(19) United States
(12) Patent Application Publication
(10) Pub. No.: US 2021/0349437 A1
(43) Pub. Date: Nov. 11, 2021

(54) System and Method for Acquiring Inherent Energy Efficiency Factor Function of Computerized Numerically Controlled Machine Tool

(71) Applicant: Chongqing University, Chongqing (CN)

(72) Inventors: Peiji LIU, Chongqing (CN); Fei LIU, Chongqing (CN); Junbo TUO, Chongqing (CN); Xu Wang, Chongging (CN)

(21) Appl. No.: 17/271,642

(22) PCT Filed: Feb. 26, 2019
(86) PCT No.: PCT/CN2019/076155

§ 371 Date: Feb. 26, 2021

(30) Foreign Application Priority Data
Jan. 29, 2019 (CN) 201910087195.0

(51) Int. Cl. G05B 19/406

(52) U.S. Cl. CPC G05B 19/406; G05B 2219/39407; G05B 2219/33099

(57) ABSTRACT

The disclosure discloses a system for acquiring an inherent energy efficiency factor function of a CNC machine tool, the system comprises an equipment information management module, a test parameter setting module, a NC code generation module, a field test management module, a data analysis module, a validity verification module and power sensors. The NC code generation module is used to generate the NC code to control the operation of the CNC machine tool to be tested according to the test parameters and information of the CNC machine tool to be tested. The field test management module is used to analyze the power data information of power sensors and generate the input power sets of CNC machine tool in each test operation process; The data analysis module is used to generate the inherent energy efficiency factor function according to the input power set.

### CROSS-REFERENCE TO RELATED APPLICATIONS

The present disclosure takes the Chinese Patent Application No. 201910087195.0, filed on Jan. 29, 2019, and entitled “a system and a method for acquiring an inherent energy efficiency factor function of a computerized numerically controlled machine tool”, as the priority, the entire contents of which are incorporated herein by reference.

### TECHNICAL FIELD

The disclosure relates to the field of mechanical processing technology, especially a system and a method for acquiring an inherent energy efficiency factor function of a computerized numerically controlled (CNC) machine tool.

### BACKGROUND

CNC machine tool is a typical equipment in manufacturing system. Due to a large amount of CNC machine tools, huge total energy consumption, but low energy efficiency nor attention, how to improve the energy efficiency of CNC machine tool is rising rapidly in the world. In recent years, we have found that the fundamental reason for the different energy efficiency of different CNC machine tools is that their inherent energy efficiency factors are different. Moreover, the inherent energy efficiency factor is generated in the design and formation stage of CNC machine tool and acts on its service stage. Therefore, how to optimize the inherent energy efficiency factors of the CNC machine tool in the design and formation stage has become a research focus on improving the energy efficiency of the CNC machine tool. At the same time, it is urgent to systematically obtain the inherent energy efficiency factors of the CNC machine tool to provide support for the improvement of the energy efficiency of the CNC machine tool.

In recent years, researchers have done a lot of research on the energy consumption of the spindle system and feed shaft system which is the main body of the energy consumption of CNC machine tool. Studies in the literature “Lv, J., et al., Experimental study on energy consumption of computer CNC machine tool. Journal of Cleaner Production, 2016.112: p. 3864-3874.” and literature “Rief, M., B. Karpuschewski, and E. Kalhöfer, Evaluation and modeling of the energy demand during machining. CIRP Journal of Manufacturing Science and Technology, 2017. 19: p. 62-71” indicate that the spindle systems of different machine tools have different idling energy consumption characteristics; In particular, the idling power of many spindles is a piecewise quadratic curve with spindle speed. The disclosure patent “A method for obtaining non-cutting energy consumption of the main drive system of a numerical control lathe” (ZL201210240326.2) discloses a method for calculating the power and energy consumption values of the spindle idling and spindle acceleration; This method needs to carry out many experiments to obtain the idling power of the main drive system inverter and the main shaft motor, the friction torque of the main shaft, the rotational inertia of the main drive system and the anglar acceleration of the main shaft, and the one-dimensional linear regression analysis is used to establish the idling power function of the main shaft. The disclosure patent “Acquirement and Energy Saving Control Method of Spindle Speeding up Power and Energy Consumption of CNC Machine Tool’ (ZL2014100958720) discloses a method to obtain spindle speeding up power and energy consumption of CNC machine tool; This method needs to measure and record the spindle rotation power and energy consumption for many times, and needs to draw the power-speed curve of the experiment manually. By observing the curve slope changes to determine the piecewise points of the piecewise linear regression analysis. The disclosure patent “The acquisition and control method of power and energy consumption of CNC machine tool in rapid feed&return stage” (ZL201410083510X) published a method to calculate the energy consumption of in rapid feed&return stage according to the parameters of feed motion power, feed acceleration, feed deceleration, feed critical distance and feed distance.

This method needs to detect and record the feed motion power many times to establish the relationship between feed motion power and feed speed. The disclosure patent ‘The acquisition and energy-saving control method of power and energy consumption of CNC machine tool in drilling process’ (2017112859823) published a prediction method of power and energy consumption of machine tool drilling based on machine standby power, jet cutting fluid power, spindle rotation power, and Z-axis feed power; This method needs to repeatedly detect and record the spindle rotation power and Z-axis feed power, and then uses the linear regression to fit the spindle rotation power, and uses the quadratic polynomial to fit the Z-axis feed power. The disclosure patent ‘accurate prediction method of energy consumption for automatic tool change of multi-station rotary tool holder of CNC lathe’ (2018100249991) published a prediction method of energy consumption for automatic tool change of CNC lathe; This method needs to measure and record tool changing time many times to establish the prediction model of automatic tool changing time.

In summary, due to difficulties in the detection process of the inherent energy efficiency factors, the existing technology has the following problems:

(1) Incomplete detection data. The existing detection methods focus on the power and energy consumption of the machine tool spindle system and feed shaft system, and the inherent energy efficiency factors of the CNC machine tool, comprising the standby power function of the CNC machine tool, the auxiliary system power function of the CNC machine tool, the energy consumption function and the starting time function of the spindle system in the starting process, the power function of the spindle system in the empty operation process, the power function of the feed shaft system in the cutting process, the energy consumption function and the time function of the feed shaft system in the fast feed tool withdrawal process, the energy consumption function and the time function of the workpiece automatic loading and unloading system, and the energy consumption function and the time function of the automatic tool changing system. Therefore, the existing detection methods lack the systematic and comprehensive measurement of the inherent energy efficiency factors of the CNC machine tool from the overall perspective.

(2) Data processing is complicated. The existing detection methods need to be measured and recorded manually many times, which is cumbersome to operate and difficult to promote.

(3) Single fitting model. Existing detection methods focus on the use of linear regression fitting spindle idling power, and quadratic polynomial fitting feed shaft power; However, the existing theoretical research and actual measurement results show that: different spindle system and feed shaft system, there are often different power requirements; Simple linear regression or quadratic polynomial fitting cannot meet the requirements.

### SUMMARY

Because of the shortcomings of the above existing technology, the disclosure provides a system for acquiring an inherent energy efficiency factor function of a computerized numerically controlled (CNC) machine tool, the system can automatically generate the NC code required to obtain the inherent energy efficiency factors of CNC machine tool, and can adaptively select the fitting function type for different CNC machine tool, and establish the inherent energy efficiency factor function of CNC machine tool and its energy consumption subsystem.

To solve the above technical problems, the technical scheme of the disclosure is as follows: a system for acquiring an inherent energy efficiency factor function of a CNC machine tool, wherein the CNC machine tool includes the following energy consumption subsystem: a numerical control system, a spindle system, a feed shaft system, an automatic tool changing system and an auxiliary system; the system comprises an equipment information management module, a test parameter setting module, an NC code generation module, a field test management module, a data analysis module, and power sensors used to obtain the running power data of the CNC machine tool to be tested;

equipment information management module is used to input basic information, spindle system information, feed shaft system information, automatic tool automatic tool changing system information, and auxiliary system information of CNC machine tool to be tested;

the test parameter setting module is used to set the test parameters comprising the state-running duration tₒ, the state switching flag time t_{d}, the state-switching-delay duration t_{dc}, the number of test samples Nₜᵣ, and the initial distance d_{I-o} of the feed shaft;

the NC code generation module is used to generate NC code to control the operation of NC machine tool to be tested according to the test parameters and the basic information of NC machine tool to be tested, spindle system information, feed shaft system information, tool automatic tool changing system information, and auxiliary system information, the NC code includes the NC code used to control the operation of the spindle system during the test procedure, the NC code used to control the operation of the feed shaft system during the test procedure, the NC code used to control the operation of the automatic tool changing system during the test procedure, and the NC code used to control the operation of the auxiliary system during the test procedure;

the field test management module is used to set the power sensors parameters, read the power data information of the power sensors, parse the power data information of the power sensors, and generate the power set;

the data analysis module is used to generate the inherent energy efficiency factor function of each energy consumption subsystem according to the power set of the CNC machine tool to be tested during the test operation, and generate the inherent energy efficiency factor function of each operation stage of the NC machine tool according to the inherent energy efficiency factor function of each energy consumption subsystem.

Optionally, the basic information includes machine tool type, machine tool model, and CNC system type, The information of spindle system includes the maximum speed n_{S-max}, the minimum speed n_{S-min}, the rated speed n_{S-r}, the interval Δ_{S-n-u} above the rated speed, and the interval Δ_{S-n-l} below the rated speed. The information of feed shaft system includes the fast feed speed fv_{I-max} in the direction of the I axis, the axial stroke d_{I}, and the highest cutting feed speed cv_{I-max}, the subscript I∈[X, Y, Z], X, Y, Z respectively represent the X-axis, Y-axis, and Z-axis of the machine tool, The information of automatic tool automatic tool changing system includes the number of tool positions Nₜ, the information of auxiliary system includes the total number of auxiliary systems controlled by CNC system N_{Au}, the name of each auxiliary system and the control code of each auxiliary system.

Optionally, the NC code used to control the operation of the spindle system in the test process includes the spindle start speed setting code, The total number of spindle speed tests is 2Nₜᵣ, and the i-th spindle speed ns_{S-tr[i]} is set as follows:

$$n {s}_{S - tr} [ i ] = \{ \begin{matrix}{n}_{S - r} - {Δ}_{S - n - l} ⌊ \frac{{n}_{S - min} - {n}_{S - r}}{{N}_{t r} {Δ}_{S - n - l}} ⌋ ( i - {N}_{t r} ) , 0 \leq i < {N}_{t r} \\ {n}_{S - r} + {Δ}_{S - n - u} ⌊ \frac{{n}_{S - max} - {n}_{S - r}}{{N}_{t r} {Δ}_{S - n - u}} ⌋ ( i - {N}_{t r} ) , {N}_{t r} \leq i \leq 2 {N}_{t r}\end{matrix} ; \qquad$$

where └ ┘ denotes the integer operation;

the NC code used to control the operation of the feed shaft system during the test includes the rapid feed&return distance setting code, among them, the total number of rapid feed&return distance test is Nₜᵣ, and set the i-th rapid feed&return distance d_{I-tr[i]} according to the following formula:

$${d}_{i - tr} [ i ] = {d}_{i - o} + \frac{{d}_{i} - 2 {d}_{i - o}}{{N}_{tr}} j ,$$

where 1≤i≤Nₜᵣ, d_{I} is the axial stroke of the feed shaft in the direction of I axis, d_{I-o} is the initial distance of the feed shaft in the direction of I axis;

the NC code used to control the feed shaft system during testing also includes cutting feed rate setting code, Among them, the total number of cutting feed rate test is Nₜᵣ, and according to the following formula to set the i-th cutting feed rate cv_{I-tr[i]}:

$$c {v}_{I - tr} [ j ] = \frac{c {v}_{i - max}}{{N}_{t r}} j ,$$

where 1≤i≤Nₜᵣ, The subscript I∈[X, Y, Z], and X, Y, Z represent the X-axis, Y-axis, and Z-axis of the machine tool, respectively, cv_{I-max} represents the maximum cutting speed in the direction of I axis.

Optionally, the power set generated by the field test management module according to the power data information collected by the power sensors in the test experiment of CNC machine tool includes: the input power set D of CNC machine tool in the process of power supply opening; the input power set D_{SC} of CNC machine tool in the process of CNC system operation; The input power set D_{Au-i}, 1≤i≤N_{AU} of CNC machine tool in the operation process of the i-th (i^{th}) auxiliary system; The input power set D_{PS-i}, 1≤i≤2Nₜᵣ of CNC machine tool in the starting process of the i-th spindle speed; The input power set D_{US-i}, 1≤i≤2Nₜᵣ of CNC machine tool in the i-th spindle speed empty operation process; The input power set D_{I-PF-i}, I∈[X, Y, Z], 1≤i≤Nₜᵣ, of CNC machine tool in the rapid feed&return process of feed shaft I with the i-th rapid feed&return distance; The input power set D_{I-UF-i}, I∈[X, Y, Z], 1≤i≤Nₜᵣ, of CNC machine tool cutting feed process at the i-th cutting feed rate in feed shaft I; The input power set D_{PT-n}_{ₜ}, 1≤nₜ≤Nₜ of the CNC machine tool in the process of changing the nₜ tool position in the automatic tool changing system.

Optionally, a discrete modeling method is used in the data analysis module to establish the discrete function of the inherent energy efficiency factors of each energy consumption subsystem of CNC machine tool, comprises the following steps:

step 2.1: calculating a power mean P̅_̅{̅D̅}̅, a set time t_{D} and a set energy consumption E_{D} for each power set, according to following general formula:

$$\overline{{P}_{D}} = \frac{1}{{N}_{D}} {\sum }_{k = 1}^{{N}_{D}} {P}_{k} , {P}_{k} ∈ D ; {t}_{D} = \frac{{N}_{D}}{f s} ; {E}_{D} = \frac{1}{f s} {\sum }_{k = 1}^{{N}_{D}} {P}_{k} , {P}_{k} ∈ D ,$$

wherein D represents the power set, Pₖ represents a k-th element in the power set D, N_{D} represents the number of elements in the power set D, and fs represents a sampling frequency of the power sensors;

step 2.2: setting up the inherent energy efficiency factor discrete function of each energy consumption subsystem of the CNC machine tool:

wherein a power consumption PSP of the CNC machine tool in a power supply opening process:

P_{SP}=P̅_̅{̅i̅n̅-̅S̅P̅}̅,

and P̅_̅{̅i̅n̅-̅S̅P̅}̅ represents a power average of the power set D_{SP} of the CNC machine tool in the power supply opening process,

a power consumption of a control system of the CNC machine tool P_{Cs}:

P_{Cs}=P̅_̅{̅i̅n̅-̅S̅C̅}̅−P_{SP},

and P̅_̅{̅m̅-̅S̅c̅}̅ represents a power mean of the power set D_{SC} of the CNC machine tool in the operation process of the CNC system,

a power consumption of the auxiliary system P_{Au-i}:

P_{Au-i}=P̅_̅{̅i̅n̅-̅A̅u̅-̅i̅}̅−P̅_̅{̅i̅n̅-̅S̅C̅}̅,

and P̅_̅{̅i̅n̅-̅A̅u̅-̅i̅}̅ represents a power average of the power set D_{Au-i} of the CNC machine tool during the operation of the i-th auxiliary system, 1≤i≤N_{Au},

a discrete function of startup time and energy consumption of the spindle system is C_{S-PS}:

$${C}_{S - PS} = [ \begin{matrix}n & {t}_{S - PS} & {E}_{S - PS}\end{matrix} ] = [ \begin{matrix}{ns}_{S - tr} [ 1 ] & {t}_{S - PS} [ 1 ] & {E}_{S - PS} [ 1 ] \\ ⋮ & ⋮ & ⋮ \\ {ns}_{S - tr} [ i ] & {t}_{S - PS} [ i ] & {E}_{S - PS} [ i ] \\ ⋮ & ⋮ & ⋮ \\ {ns}_{S - tr} [ 2 {N}_{tr} ] & {t}_{S - PS} [ 2 {N}_{tr} ] & {E}_{S - PS} [ 2 {N}_{tr} ]\end{matrix} ] , \qquad$$

and n represents a spindle speed and is an independent variable; both t_{S-PS} and E_{S-PS} are dependent variables, which are a starting time of the spindle system and an energy consumption of the spindle system. the t_{S-PS}[i] is a running time of the power set D_{PS-i} in the starting process of the CNC machine tool in the start-up process of the i-th spindle speed, 1≤i≤2Nₜᵣ,

a calculation formula of E_{S-PS}[i] is as follows:

E_{S-PS}[i]=E_{in-PS}[i]−P̅_̅{̅i̅n̅-̅S̅C̅}̅t_{S-PS}[i],

and E_{S-PS}[i] is the set energy consumption of the power set D_{PS-i} of the CNC machine tool in a start-up process of an i-th spindle speed, 1≤i≤2Nₜᵣ,

an idling power discrete function of the spindle system in a process of air operation C_{S-US}:

$${C}_{S - US} = [ \begin{matrix}n & {P}_{S - US} ]\end{matrix} = [ \begin{matrix}{ns}_{S - tr} [ 1 ] & {P}_{S - US} [ 1 ] \\ ⋮ & ⋮ \\ {ns}_{S - tr} [ i ] & {P}_{S - US} [ i ] \\ ⋮ & ⋮ \\ {ns}_{S - tr} [ 2 {N}_{tr} ] & {P}_{S - US} [ 2 {N}_{tr} ]\end{matrix} ] ,$$

and n represents the spindle speed and is the independent variable; P_{S-US} represents a power function of a spindle system in an air operation process as a dependent variable,

a calculation power formula of P_{S-US}[i] is as follows:

P_{S-US}[i]=P̅_̅{̅i̅n̅-̅U̅S̅}̅[i]−P̅_̅{̅i̅n̅-̅S̅C̅}̅,

and P̅_̅{̅i̅n̅-̅U̅S̅}̅[i] is a mean power of the power set D_{US_i} of the CNC machine tool in the process of the i-th spindle speed empty operation, 1≤i≤2Nₜᵣ,

a discrete function C_{I-PF} of a rapid feed&return time and an energy consumption of the rapid feed&return of the feed shaft system of the CNC machine tool is:

$${C}_{I - PF} = [ \begin{matrix}{d}_{I - tr} & {t}_{I - PF} & {E}_{I - PF} ]\end{matrix} = [ \begin{matrix}{d}_{I - tr} [ 1 ] & {t}_{I - P F} [ 1 ] & {E}_{I P F} [ 1 ] \\ ⋮ & ⋮ & ⋮ \\ {d}_{I - tr} [ i ] & {t}_{I - PF} [ i ] & {E}_{I - PF} [ i ] \\ ⋮ & ⋮ & ⋮ \\ {d}_{I - tr} [ {N}_{tr} ] & {t}_{I - PF} [ {N}_{tr} ] & {E}_{I - PF} [ {N}_{tr} ]\end{matrix} ] , \qquad$$

and the subscripts I∈[X, Y, Z], X, Y, Z represent the X axis, the Y axis and the Z axis of the machine tool respectively, d_{I-tr} represents a rapid feed&return distance and is an independent variable, t_{I-PP} and E_{I-PF} are dependent variables, t_{I-PF} means a rapid feed&return time, E_{I-PF} means a rapid feed&return energy consumption, t_{I-PF}[i] is a running time of a feed axis I in the power set D_{I-PF-i} of the CNC machine tool in a process of an i-th rapid feed&return distance in the feed shaft I, 1≤i≤Nₜᵣ,

a calculation formula of E_{I-FF}[i] is as follows:

E_{I-FF}[i]=E_{in-I-PF}[i]−P̅_̅{̅i̅n̅-̅S̅C̅}̅t_{I-PF}[i],

and E_{in-I-PF}[i] is a set energy consumption of the power set D_{I-PF-i} of the CNC machine tool in a process of an i-th rapid feed&return distance in the feed shaft I, I∈[X, Y, Z], 1≤i≤Nₜᵣ,

a discrete function C_{I-UF} of feed power in a cutting feed operation process of the feed shaft system is:

$${C}_{I - UF} = [ \begin{matrix}{cv}_{I - tr} & {P}_{I - UF}\end{matrix} ] = [ \begin{matrix}c {v}_{I - tr} [ 1 ] & {P}_{I U F} [ 1 ] \\ ⋮ & ⋮ \\ c {v}_{I - tr} [ i ] & {P}_{I U F} [ i ] \\ ⋮ & ⋮ \\ {cv}_{I - tr} [ {N}_{tr} ] & {P}_{I - UF} [ {N}_{tr} ]\end{matrix} ] , \qquad$$

and the subscripts I∈[X, Y, Z], X, Y, Z represent the X axis, the Y axis and the Z axis of the machine tool respectively, cv_{I-tr} represents a cutting feed rate of I axis, which is an independent variable, P_{I-UF} represents a feed power of I-axis cutting and is a dependent variable,

a calculation formula of P_{I-UF}[i] is as follows:

P_{I-UF}[i]=P̅_̅{̅i̅n̅-̅I̅-̅U̅F̅}̅[i]−P̅_̅{̅i̅n̅-̅S̅C̅}̅,

and P_{in-I-UF}[i] is a mean power of the power set D_{I-UF-i} of the CNC machine tool in the feed axis I cutting the feed process at the i-th cutting speed, I∈[X, Y, Z], 1≤i≤Nₜᵣ,

a discrete function C_{PT} of a tool changing time and energy consumption of the automatic tool changing system during a tool changing operation is:

$${C}_{P T} = [ \begin{matrix}{n}_{t} & {t}_{PT} & {E}_{PT}\end{matrix} ] = [ \begin{matrix}1 & {t}_{PT} [ 1 ] & {E}_{PT} [ 1 ] \\ ⋮ & ⋮ & ⋮ \\ {n}_{t} & {t}_{PT} [ {n}_{t} ] & {E}_{PT} [ {n}_{t} ] \\ ⋮ & ⋮ & ⋮ \\ {N}_{t} & {t}_{PT} [ {N}_{t} ] & {E}_{PT} [ {N}_{tr} ]\end{matrix} ] ,$$

and nₜ represents a tool change position and is an independent variable, t_{PT} and E_{PT} are dependent variables, t_{PT} means a tool change time, E_{PT} means a tool change energy consumption of the tool changing system, t_{PT}[nₜ] is a running time for the power set D_{PT-nt} of the CNC machine tool in a process of changing an nₜ-th tool position by the automatic tool changing system,

a calculation formula of E_{PT}[nₜ] is as follows:

E_{PT}[nₜ]=E_{in-PT}[nₜ]−P̅_̅{̅i̅n̅-̅S̅C̅}̅t_{PT}[nₜ],

and E_{in-PT}[nₜ] is a set energy consumption of the power set D_{PT-n}_{ₜ} of the CNC machine tool in a process of changing an nₜ-th tool position by the automatic tool changing system, 1≤nₜ≤Nₜ.

Optionally, based on discrete modeling, the data analysis module uses the adaptive fitting modeling method to establish the fitting function of the inherent energy efficiency factors of each energy consumption subsystem of CNC machine tool, comprises the following steps:

step 2.3: regarding the inherent energy efficiency factor discrete function of each energy consumption subsystem of the CNC machine tool established by the discrete modeling method as a data set for fitting, and dividing the data set into a training set and a test set by a cross-validation method in machine learning;

step 2.4: fitting a first fitting function and a second fitting function by a least square method according to the training set;

step 2.5: by the test set, calculating errors of the first fitting function and the second fitting function according to an error function;

step 2.6: If the error of the first fitting function is less than the error of the second fitting function, selecting the first fitting function as the inherent energy efficiency factor function, otherwise, selecting the second fitting function as the inherent energy efficiency factor function;

therefore, establishing following fitting functions of each energy consumption subsystem:

the spindle system of CNC machine tool: a fitting function of a starting time length t_{S-PS}(n), a fitting function of a starting energy consumption E_{S-PS}(n) and a fitting function of an air operation power P_{S-US}(n) which are with the spindle speed n as the independent variable respectively;

the feed shaft system of CNC machine tool: a rapid feed&return time fitting function t_{I-PF}(d_{I}) which is with a rapid feed&return distance d_{I} as an independent variable, a rapid feed&return energy consumption fitting function E_{I-PF}(d_{I}) which is with the rapid feed&return distance d_{I} as the independent variable, a cutting feed power fitting function P_{I-UF}(cv_{I}) with a cutting feed rate cv_{I} as a independent variable, and the subscript I∈[X, Y, Z], X, Y, Z represent the X axis, the Y axis and the Z axis of the machine tool respectively;

the automatic tool changing system: a tool change time fitting function t_{PT}(nₜ) and a tool change energy consumption fitting function E_{PT}(nₜ) which are with the tool change position nₜ as an independent variable.

Optionally, the inherent energy efficiency factor functions of CNC machine tool include the power function P_{in-S}(s_{Cs}) of CNC machine tool in standby stage, the power function P_{in_PA}(s_{Au_t}) of CNC machine tool in auxiliary system opening stage, the energy consumption function E_{in-PS}(n, s_{Au-i}) of CNC machine tool in spindle system starting stage, the energy consumption function E_{in-PF}(d, s_{Au-t}) of CNC machine tool in rapid feed&return stage, the energy consumption function E_{in-PT}(nₜ, s_{Au-i}) of CNC machine tool in automatic tool changing stage, and the power function P_{in-U} (n, cv_{I}, s_{Au-t}) of CNC machine tool in the idling stage, specific expressions are as follows:

the power function P_{in-S}(s_{Cs}) of CNC machine tool in the standby stage:

P_{in-S}(s_{Cs})=P_{SP}+s_{Cs}P_{Cs};

and P_{SP} represents a power consumption when a CNC machine tool power is turned on, and P_{Cs} represents a new power consumption when the CNC machine tool power is turned on, s_{Cs} means a state of the CNC system, s_{Cs}=0 means the state of the CNC system is closed, s_{Cs}=1 means the state of the CNC system is open;

the power function of the CNC machine tool in an opening stage of the auxiliary system P_{in-PA}(s_{Au-i}):

P_{in-PA}(s_{Au-i})=P_{S}+Σs_{Au-i}P_{Au-i},

P_{S} represents a standby power of CNC machine tool, P_{S}=P_{in-S}(s_{Cs}=1); P_{Au-i} means a new machine tool power consumption when a first auxiliary system is opened, 1≤i≤N_{Au}; s_{Au-i} represents a state of the i-th auxiliary system, 1≤i≤N_{Au}, s_{Au-i}=0 represents a closed state of the i-th auxiliary system, and s_{Au-i}=1 represents an open state of the i-th auxiliary system;

the energy consumption function E_{in-PS}(n,s_{Au-i}) of CNC machine tool in the starting stage of the spindle system:

E_{in-PF}(d_{I},s_{Au-i})=(P_{S}+Σs_{Au-I}P_{Au-t})t_{S-PS}(n)+E_{S-PS}(n),

and n denotes the spindle speed, t_{S-PS}(n) and E_{S-PS}(n) are a starting time function and an energy consumption function of the spindle system, respectively;

the energy consumption function E_{in-PF}(d_{I},s_{Au-i}) of CNC machine tool in the rapid feed&return stage:

E_{in-PF}(d_{I},s_{Au-i})=(P_{S}+Σs_{Au-i}P_{Au-i})Σt_{I-PF}(d_{I})+ΣE_{I-PF}(d_{I}),

and t_{PT}(nₜ) and E_{PT}(nₜ) represent the rapid feed&return time fitting function, the rapid feed&return energy consumption fitting function of I axis respectively;

the energy consumption function E_{in-PT}(nₜ,s_{Au-i}) of CNC machine tool in the automatic tool change stage:

E_{in-PT}(nₜ,s_{Au-i})=(P_{S}+Σs_{Au-i}P_{Au-i})t_{PT}(nₜ)+E_{PT}(nₜ),

and nₜ represents the number of cutter positions that need to be rotated during automatic tool change; t_{PT}(nₜ) and E_{PT}(nₜ) represents the tool change time fitting function and the tool change energy consumption fitting function of the automatic tool changing system respectively;

the power function P_{in-U}(n,cv_{I},s_{Au-i}) in the idling stage of the CNC machine tool:

P_{in-U}(n,cv_{I},s_{Au-i})=P_{S}+P_{S-US}(n)+Σs_{Au-i}P_{Au-i}+ΣP_{I-UF}(cv_{I}),

Where P_{S-US}(n) represents the a fitting function of an air operation power of the spindle system; cv_{I} represents the feed rate and P_{I-UF}(cv_{I}) represents the a cutting feed power fitting function of the I axis.

Optionally, a validity verification module for verifying the validity of the inherent energy efficiency factor function is also included. The validity verification module judges whether the inherent energy efficiency factor function is valid according to the error between the verification value and the predicted value;

the verification value is obtained by the verification experiment, and the predicted value is calculated by the data analysis module according to the operation conditions of the verification experiment and the inherent energy efficiency factor function of the CNC machine tool in each operation stage;

for verification experiments, the NC code generation module and field test management are improved as follows:

the NC code generation module is also used to generate the verification experiment NC code for verification experiment according to the test parameters, the basic information, the spindle system information, the feed shaft system information, the tool automatic tool changing system information and the auxiliary system information of the NC machine tool to be tested. The verification experiment NC code for verification experiment includes the NC code for controlling the operation of the auxiliary system in the verification experiment, the NC code for controlling the spindle system to start and run at the specified speed n_{S-V} in the verification experiment, the NC code for controlling the feed shaft system to run at the specified rapid feed&return distance d_{I-V} and the specified cutting feed speed cv_{I-V} in the verification experiment, and the NC code for controlling the automatic tool changing system to run at the specified tool position n_{t-V} in the verification experiment;

the power set generated by the field test management module according to the power data information collected by the power sensors in the verification experiment of the CNC machine tool includes: the input power set D_{SC-V} of the CNC machine tool in the operation process of the numerical control system, the input power set D_{Au-V} of the CNC machine tool in the whole operation process of the auxiliary system, the input power set D_{PS-V} of the CNC machine tool in the spindle system according to the specified speed n_{S-V} the input power set D_{US-V} of the CNC machine tool in the spindle system according to the specified speed n_{S-V} the input power set D_{I-PF-V} of the CNC machine tool in the feed shaft I (I∈[X, Y, Z]) in the process of the specified rapid feed&return distance d_{I-V} and the input power set D_{I-UF-V} of the CNC machine tool in the automatic tool.

The disclosure also provides a method for obtaining an inherent energy efficiency factor of a CNC machine tool, adopts the inherent energy efficiency factor function acquisition system of the CNC machine tool, establishes the inherent energy efficiency factor function of each energy consumption subsystem and the inherent energy efficiency factor function of each operation stage of the CNC machine tool, and calculates the inherent energy efficiency factor of the CNC machine tool in different operation stages according to the inherent energy efficiency factor function of the CNC machine tool, which includes the following steps:

step A1: equipment information management module inputting basic information, active system information, and auxiliary system information of the CNC machine tool to be tested;

step A2: setting test parameters in a test parameter setting module, wherein the test parameters comprise: a state-running duration tₒ, a state switching flag time t_{d}, a state-switching-delay duration t_{dc}, the number of test samples Nₜᵣ and an initial distance of a feed shaft d_{I-o};

step A3: generating NC codes of a test experiment in a NC code generation module according to the test parameters in step A2, the basic information, the spindle system information, the feed shaft system information, the tool automatic tool changing system information, and the auxiliary system information of the CNC machine tool in step A1;

step A4: setting power sensors parameters in a field test module, and inputting the NC codes of the test experiment into a CNC system of the CNC machine tool to be tested;

step A5: the CNC machine tool running the NC codes of the test experiment and controlling the CNC machine tool to be tested to run according to the NC codes of the test experiment, at the same time, collecting power data information of each energy consumption subsystem in the test experiment of the CNC machine tool to be tested by the power sensors installed on the CNC machine tool to be tested, generating a power set of each energy consumption subsystem in the test experiment by the field test management module according to the power data information collected by the power sensors;

step A6: a data analysis module establishing the inherent energy efficiency factor function of each energy consumption subsystem according to the power set in step A5;

step A7: the data analysis module establishing the inherent energy efficiency factor function of CNC machine tool in each operation stage according to the inherent energy efficiency factor function of each energy consumption subsystem in step A6;

step A8: according to the inherent energy efficiency factor function of CNC machine tool in each operation stage and operating conditions of CNC machine tool, calculating inherent energy efficiency factors in each operation stage of CNC machine tool.

The disclosure also provides another method for obtaining the inherent energy efficiency factors of CNC machine tool, adopts the system for acquiring inherent energy efficiency factor function of CNC machine tool, establishes the inherent energy efficiency factor function of each energy consumption subsystem and the inherent energy efficiency factor function of each operation stage of CNC machine tool, and calculates the inherent energy efficiency factors of CNC machine tool in different operation stages according to the inherent energy efficiency factor function of CNC machine tool, which includes the following steps:

step B1: equipment information management module inputting basic information, active system information, and auxiliary system information of the CNC machine tool to be tested;

step B2: setting test parameters in a test parameter setting module, wherein the test parameters comprise: a state-running duration tₒ, a state switching flag time t_{d}, a state-switching-delay duration t_{dc}, the number of test samples Nₜᵣ and an initial distance of a feed shaft d_{I-o};

step B3: generating NC codes of a test experiment and NC codes of a verification experiment in a NC code generation module according to the test parameters in step B2, the basic information, the spindle system information, the feed shaft system information, the tool automatic tool changing system information, and the auxiliary system information of the CNC machine tool in step B1;

step B4: setting power sensors parameters in a field test module, and inputting the NC codes of the test experiment and the NC codes of the verification experiment into a CNC system of the CNC machine tool to be tested;

step B5: the CNC machine tool running the NC codes of the test experiment and controlling the CNC machine tool to be tested to run according to the NC codes of the test experiment, at the same time, collecting power data information of each energy consumption subsystem in the test experiment of the CNC machine tool to be tested by the power sensors installed on the CNC machine tool to be tested, generating a power set of each energy consumption subsystem in the test experiment by the field test management module according to the power data information collected by the power sensors;

step B6: the CNC machine tool running the NC codes of the verification experiment and controlling the CNC machine tool to be tested to run according to the NC codes of the verification experiment, at the same time, collecting power data information of each energy consumption subsystem in the test experiment of the CNC machine tool to be tested by the power sensors installed on the CNC machine tool to be tested, generating a power set of each energy consumption subsystem in the verification experiment by the field test management module according to the power data information collected by the power sensors;

step B7: a data analysis module establishing the inherent energy efficiency factor function of each energy consumption subsystem according to the power set of the test experiment in step B5;

step B8: the data analysis module establishing the inherent energy efficiency factor function of CNC machine tool in each operation stage according to the inherent energy efficiency factor function of each energy consumption subsystem in step A6;

step B9: a validity verification module carrying out a validity verification of the inherent energy efficiency factor function of the CNC machine tool generated by the data analysis module, if the inherent energy efficiency factor function passes the validity verification, Entering step B10. if the inherent energy efficiency factor function fails to pass the validity verification, repeating steps B1 to B9, if still fail to pass the validity verification, contact technical personnel to eliminate the problem;

step B10: according to the inherent energy efficiency factor function of CNC machine tool in each operation stage and operating conditions of CNC machine tool, calculating inherent energy efficiency factors in each operation stage of CNC machine tool.

Compared with the prior art, the present disclosure has the following beneficial effects:

1. The disclosure is a set of experimental design, experimental implementation, and data acquisition and analysis integration system for obtaining the inherent energy efficiency factor function of CNC machine tool; The system can systematically and comprehensively detect and obtain the power function of CNC machine tool in standby stage, auxiliary system operation stage, energy consumption function and start-up time function in start-up stage, energy consumption function and time function in rapid feed&return stage, energy consumption function and time function in automatic tool changing stage and power function in the idling stage; The system of inherent energy efficiency factors obtained by testing is comprehensive, which helps the producer to understand the energy consumption of CNC machine tool and make energy-saving plans.

2. The disclosure can directly generate detection NC code and detection steps by filling in the basic information of CNC machine tool and detection parameters information; On-site testing only need to carry out experiments following the detection steps, and use sensors to measure the input power of CNC machine tool; After obtaining the test data, the software system automatically analyzes and processes the data to obtain the inherent energy efficiency factor function; The disclosure does not require manual design experiment and manual processing experiment data, has good operability, is easy to expand, and is convenient and practical.

3. The self-adaptive modeling method is adopted in the disclosure system, which has higher accuracy than the traditional fixed-function modeling method.

4. The inherent energy efficiency factor function of CNC machine tool obtained by the disclosure can provide technical support for the energy efficiency evaluation of new machine tools and the energy efficiency improvement of old machine tools, and has broad disclosure prospects.

### BRIEF DESCRIPTION OF THE DRAWINGS

FIG. 1 shows the inherent energy efficiency factor function acquisition system framework of the CNC machine tool;

FIG. 2 shows the installation of the power sensors.

### DETAILED DESCRIPTION OF THE EMBODIMENTS

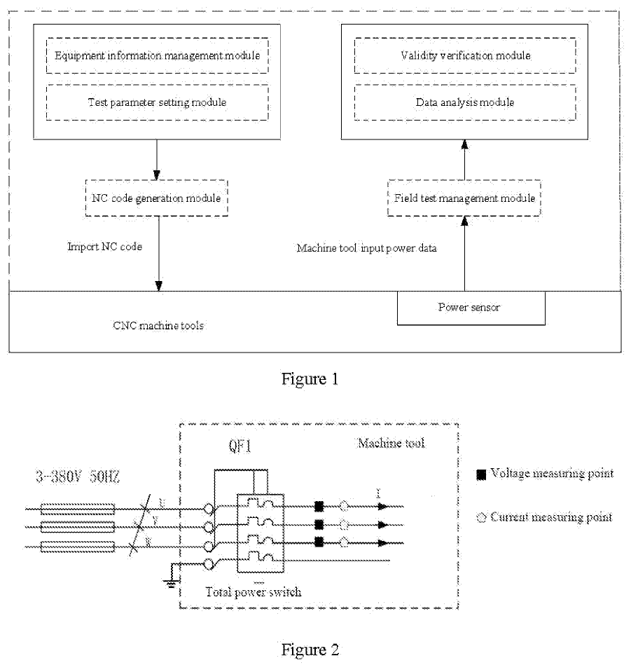

FIG. 1 is the inherent energy efficiency factor function acquisition system framework of the CNC machine tool; The vertical CNC milling center XK714D is tested by using the inherent energy efficiency factor function acquisition system and acquisition method of the CNC machine tool. The process is as follows:

Step 1: The equipment information management module inputs the basic information, the spindle system information, the feed shaft system information, the automatic tool automatic tool changing system information, and the auxiliary system information of the CNC machine tool to be tested, as follows:

TABLE 1
Basic information on CNC machine tool
Basic information of CNC machine tool

| | |
|---|---|
| Machine type | Vertical CNC milling center |
| Machine model | XK714D |
| CNC system | FANU |

TABLE 2
Spindle system information
Spindle system information

| | |
|---|---|
| Rated speed r/min | 750 |
| Minimum rotation speed r/min | 60 |
| Maximum rotation speed r/min | 80000 |
| Speed interval above rated speed r/min | 250 |
| Speed interval below rated speed r/min | 50 |

TABLE 3
Feed shaft system information

| Feed shaft system information | X | Y | Z |
|---|---|---|---|
| Rapid feed&return speed mm/min | 20000 | 20000 | 15000 |
| Cutting feed rate mm/min | 5000 | 5000 | 5000 |
| Range of motion mm | 400 | 300 | 300 |

TABLE 4
Automatic Tool automatic tool changing system information

| | |
|---|---|
| The maximum number of cutting tools in | 12 |
| Automatic Tool Changing System | |

TABLE 5
Auxiliary System Information

| Auxiliary System | | | |
|---|---|---|---|
| Information | 1 | 2 | 3 |
| Name | compressed air | cutting fluid | Chip |
| | system | system | transportation |
| | | | system |
| Start code | M07 | M08 | M45 |
| Stop code | M09 | M09 | M46 |

Step 2: Set the test parameters in the test parameter setting module, comprising the following test parameters: state-running duration tₒ, state switching flag time t_{d}, state-switching-delay duration t_{dc}, the number of test samples Nₜᵣ, and the initial distance of feed shaft d_{I-o}; As shown in Table 6:

TABLE 6
Parameter information
Test parameter

| | | |
|---|---|---|
| State-running duration tₒ | 10 | s |
| State-switching-mark duration t_{d} | 5 | s |
| State-switching-delay duration t_{dc} | 20 | s |
| Number of training samples Nₜᵣ | 10 | s |
| Initial distance d_{I-o} of feed shaft i | 50 | mm |

Step 3: According to the test parameters in Step 2 and the basic information, active power system information, and auxiliary system information of CNC machine tool in Step 1, the NC code of the test experiment and the NC code of the verification experiment are generated in the NC code generation module; NC code generation rules for each axis are consistent, and here, for example only X-axis:

The NC code generation rule of the spindle system is:

i values from 1 to 2 Nₜᵣ, generating the following code in turn:
G97 S ns_{S-tr}[i];
M03;
G04 X tₒ;
M05;
G04 X tₒ

Among them, the code ‘G97 S ns_{S-tr}[i]’ indicates that the spindle starting speed is set to ns_{S-tr}[i] The code ‘M03’ represents the spindle forward start: The code ‘M05’ indicates that the spindle stops rotating; The code ‘G04 X tₒ’ means running the next code after the tₒ is suspended; At the same time, the calculation formula of ns_{S-tr}[i] is as follows:

$$n {s}_{S - tr} [ i ] = \{ \begin{matrix}{n}_{S - r} - {Δ}_{S - n - l} ⌊ \frac{{n}_{S - min} - {n}_{S - r}}{{N}_{t r} {Δ}_{S - n - l}} ⌋ ( i - {N}_{t r} ) , 0 \leq i < {N}_{t r} \\ {n}_{S - r} + {Δ}_{S - n - u} ⌊ \frac{{n}_{S - max} - {n}_{S - r}}{{N}_{t r} {Δ}_{S - n - u}} ⌋ ( i - {N}_{t r} ) , {N}_{t r} \leq i \leq 2 {N}_{t r}\end{matrix} ; \qquad$$

The total number of speed tests is 2 Nₜᵣ; 0<i≤2Nₜᵣ; Where └ ┘ denotes the integer operation;

NC code generation rules of the feed shaft system include rapid feed&return test code generation rules and cutting feed generation rules, rapid feed&return test code generation rules are as follows:

i values from 1 to 2 Nₜᵣ, generating the following code in turn:
G00 X d_{X-tr}[i];
G04 X tₒ;
G04X d_{X-o};
G04 X t_{d}

Where ‘G00X d_{X-tr}[i]’ denotes the specified distance d_{X-tr}[i] for fast forward and backward in the X direction; At the same time, the calculation formula of d_{X-tr}[i] is as follows:

$${d}_{X - tr} [ i ] = {d}_{X - o} + \frac{{d}_{X} - 2 {d}_{X - o}}{{N}_{t r}} i ; \qquad$$

Among them, the total number of tests of rapid feed&return specified distance is Nₜᵣ; 1≤i≤Nₜᵣ.

The generation rules for cutting feed test code are as follows:

i values from 1 to 2 Nₜᵣ, generating the following code in turn:
G01 X d_{X-tr}[j]F cv_{X-tr}[i];
G04 X tₒ;
G00 X d_{X-o}F cv_{X-tr}[i];
G04 X t_{d}

The code ‘G01X d_{X-tr}[j] F cv_{X-tr}[i]’ represents the specified feeding speed cvX-tr[i] to the direction of the X-axis dX-tr[i] The calculation formula CvX-tr[i] is as follows:

$${cv}_{X - tr} [ i ] = \frac{{cv}_{X - max}}{{N}_{tr}} i ;$$

The total number of cutting feed rate tests is Nₜᵣ, 1≤i≤Nₜᵣ; cv_{X-max} represents the maximum cutting feed rate in the X-axis direction.

The NC code generation rules for testing the automatic tool changing system are:

i values from 2 to Nₜ, generating the following code in turn:
Ti; M06;
G04 X tₒ;
T1; M06
G04 X t_{d}

Among them, code ‘Ti; M06’ means replacing the i-th knife.

NC code generation rules for other auxiliary systems of machine tool control start and stop are:

i values from 1 to N_{Au}, generating the following code in turn:
M NCᵢ₋ₛ;
G04 X t₀;
M NCₜ₋ₚ;
G04 X t_{d}

Among them, M NCᵢ₋ₛ represents the startup NC code of the other auxiliary system i (1≤i≤N_{Au}), M NCₜ₋ₚ represents the shutdown NC code of the other auxiliary system i.

The NC code generation rules for validation experiments are:

i values from 1 to N_{Au}, generating the following code in turn:
M NCᵢ₋ₛ

After the above code, add the following code:

$$G 04 ; X {t}_{o} ;$$

$$T \frac{{N}_{t}}{2} ; M 06 ;$$

$$G 04 X {t}_{d}$$

$$G 00 {Xd}_{X - o} {Yd}_{Y - o} {Zd}_{Z - o}$$

$$G 04 ; X {t}_{d} ;$$

$$G 97 S {n}_{s - r} ;$$

$$M 03 ;$$

$$G 04 ; X {t}_{d} ;$$

$$G 00 X 2 {d}_{X - o} Y 2 {d}_{Y - o} Z 2 {d}_{Z - o} F {cv}_{max}$$

$$G 04 ; X {t}_{d} ;$$

$$M 05 ;$$

Then, add the code generated by the following rules:

i values from 1 to N_{Au}, generating the following code in turn:
M NCᵢ₋ₚ

Specific NC code generated according to the above NC code generation rules can be referred to in Table 7-8 below:

TABLE 7
NC code preview 1

| Auxiliary system | Spindle test | Rapid feed&return |
|---|---|---|
| detection | (partial code) | (partial code) |
| M07; | . . . | . . . |
| G04 X10; | G97 S700; | G00 X80; |
| M09; | M03; | G04 X10; |
| G04 X5; | G04 X10; | G00 X50; |
| M08; | M05; | G04 X5; |
| G04 X10; | G04 X5; | G00 X110; |
| M09; | G97 S750; | G04 X10; |
| G04 X5; | M03; | G00 X50; |
| M45; | G04 X10; | G04 X5; |
| G04 X10; | M05; | G00 X140; |
| M46; | G04 X5; | G04 X10; |
| G04 X5; | . . . | . . . |

TABLE 8
NC code preview 2

| | Automatic Tool | |
|---|---|---|
| Cutting feed | Change (Part of | Confirmatory |
| (partial code) | Code) | experiment |
| . . . | . . . | M07; M08; M45 |
| G01 X80 F2000; | T3; M06; | G04; X5; |
| G04 X10; | G04 X10; | T6; M06; |
| G01 X50 F2000; | T1 M06; | G04; X5; |
| G04 X5; | G04 X5; | G00 X100 Y100 Z100 |
| G01 X110 F2500; | T4 M06; | G04; X5; |
| G04 X10; | G04 X10; | G00 X250 Y200 Z200 |
| G01 X50 F2500; | T1; M06; | G04; X5; |
| G04 X5; | G04 X5; | G97 S750; |
| G01 X140 F3000; | T5; M06; | M03; |
| G04 X10; | G04 X10; | G04; X5; |
| | | G01 X100 Y100 Z100 F5000 |
| . . . | . . . | G04; X5; |
| | | M05; M09; M46 |

Step 4: Set the power sensors parameters in the field test module, and input the NC code of the test experiment and the NC code of the verification experiment into the CNC system of the machine tool to be tested; Power sensors parameters are shown in Table 9:

TABLE 9
Power sensors information
Power sensors information

| Model | HC-33C3 |
|---|---|
| Sampling frequency fs | 20 HZ |
| Precision | ±0.5% |

Field test management module is also used to generate field test steps comprising the following steps according to test parameters:

Step X. 1: The power sensors is installed at the power input end of the CNC machine tool, and the installation position of the power sensors is shown in FIG. 2. The data output end of the power sensors is connected to the data input end of the field test management module through the conversion interface.

Step X. 2: Start the total power supply of the CNC machine tool and run continuously for tₒ time;

Step X. 3: Turn off the total power supply of CNC machine tool and wait for t_{d};

Step X. 4: Start the total power supply of the NC machine tool and run continuously for time;

Step X. 5: Start CNC system and wait for initialization;

Step X. 6: After the NC system is initialized, tₒ the duration shall be continuously run;

Step X. 7: Close the CNC system and wait for t_{d};

Step X. 8: Start the CNC system and wait for initialization;

Step X. 9: Input NC code generated by the NC code generation module into the CNC system;

Step X. 10: CNC system runs the NC code used to control the spindle system in the test experiment;

Step X. 11: Adjust the rate knob of the operating panel of the CNC machine tool, set the rate to 50%, and the CNC system runs the NC code used to control the operation of the feed shaft system in the test experiment.

Step X. 12: Adjust the rate knob of the operating panel of the CNC machine tool, set the rate to 100%, and the CNC system runs the NC code used to control the operation of the feed shaft system in the test experiment.

Step X. 13: CNC system runs the NC code used to control the operation of an automatic tool changing system in the test experiment;

Step X. 14: NC system runs the NC code used to control other auxiliary systems controlled by machine tools in the test experiment;

Step X. 15: CNC system runs the NC code for verification experiment;

Step X. 16: Turn off the CNC system of the machine tool and turn off the power supply of the machine tool.

Step 5: CNC machine tool run the NC code of the test experiment and control the test machine tools to run according to the NC code of the test experiment. At the same time, the power data information of each energy consumption subsystem in the test experiment is collected by the power sensors installed on the test machine tools. The power set of each energy consumption subsystem in the test experiment is generated by the field test management module according to the power data information collected by the power sensors.

The test power set includes: the input power set of the CNC machine tool in the power supply opening process D_{SP}, the input power set of the CNC machine tool in the numerical control system running process D_{SC}, the input power set of the CNC machine tool in the i-th (1≤i≤N_{Au}) auxiliary system running process D_{Au-i}, the input power set of the CNC machine tool in the i-th (1≤i≤2 Nₜᵣ) spindle speed starting process D_{PS-i}, the input power set of the CNC machine tool in the i-th (1≤i≤2Nₜᵣ) spindle speed running process D_{US-i}, the input power set of the CNC machine tool in the feed shaft I (I∈[X, Y, Z]) in the rapid feed&return process with i-th (1≤i≤Nₜᵣ) rapid feed&return distance D_{I-PF-i}, the input power set of the CNC machine tool in the feed shaft I (I∈[X, Y, Z]) in the i-th (1≤i≤Nₜᵣ) cutting feed speed cutting feed process D_{I-UF-i} and the input power set of the CNC machine tool in the tool changing system for the nₜ (1≤nₜ≤Nₜ) tool position tool process D_{PT-n}_{ₜ}.

Step 6: CNC machine tool run the NC code of the verification experiment and control the CNC machine tool to be tested to run according to the NC code of the verification experiment. At the same time, the power data information of each energy consumption subsystem in the verification experiment is collected by the power sensors installed on the CNC machine tool to be tested. The power set of each energy consumption subsystem in the verification experiment is generated by the field test management module according to the power data information collected by the power sensors.

The verification experiment power set includes: the input power set D_{SC_V} of NC machine tool in the operation process of NC system, the input power set D_{Au-V} of NC machine tool in the whole operation process of the auxiliary system, the input power set D_{PS-V} of NC machine tool in the spindle system starting at the specified speed n_{s-V}, the input power set D_{US-V} of CNC machine tool in the spindle system running at the specified speed n_{S-V}, the input power set D_{I-PF-V} of CNC machine tool in the feed shaft I (I∈[X, Y, Z]) in the process of rapid feed&return at the specified speed d_{I-V}, the input power set D_{I-PF-V} of CNC machine tool in the feed shaft I (I∈[X, Y, Z]) in the process of cutting at the specified feed speed cv_{I-V}, and the input power set D_{PT-V} of CNC machine tool in the automatic tool changing system.

Step 7: Data analysis module establishes the inherent energy efficiency factor function of each energy consumption subsystem according to the power set of the test experiment in step 5; The disclosure provides two function modeling methods: 1) discrete modeling method; 2) Discrete modeling method combined with an adaptive fitting modeling method; The following two function modeling methods are described respectively.

1) Discrete Modeling Method

In the data analysis module, the discrete modeling method is used to establish the discrete function of the inherent energy efficiency factors of each energy consumption subsystem of CNC machine tool, and the discrete function of the inherent energy efficiency factors is used as the inherent energy efficiency factor function, comprising the following steps:

Step 2.1: Calculate the power average P̅_̅{̅D̅}̅, run time t_{D}, and energy consumption E_{D} for each power set according to the following general formula:

$$\overline{{P}_{D}} = \frac{1}{{N}_{D}} {\sum }_{k = 1}^{{N}_{D}} {P}_{k} , {P}_{k} ∈ D ;$$

$${t}_{D} = \frac{{N}_{D}}{f s} ;$$

$${E}_{D} = \frac{1}{f s} {\sum }_{k = 1}^{{N}_{D}} {P}_{k} , {P}_{k} ∈ D$$

Among them, D represents the power set, Pₖ represents the k^{th} element in the power set D, N_{D} represents the number of elements in the power set D, and fs represents the sampling frequency of the power sensors;

Step 2.2: Set up the discrete function of inherent energy efficiency factors of energy consumption subsystem below CNC machine tool:

The power consumption of the energy dissipation subsystem of the CNC machine tool power supply opening process PSP:

P_{SP}=P̅_̅{̅i̅n̅-̅S̅P̅}̅;

Among them, P̅_̅{̅i̅n̅-̅S̅P̅}̅ represent the average power of the power set D_{SP} of CNC machine tool in the power supply opening process.

Power Consumption of CNC Machine Tool Control System P_{Cs};

P_{Cs}=P̅_̅{̅i̅n̅-̅S̅C̅}̅−P_{SP};

Among them, P̅_̅{̅i̅n̅-̅S̅C̅}̅ represent the average power of the power set D_{SC} of CNC machine tool in the CNC system operation process.

Power consumption of the CNC machine tool auxiliary system P_{Au-i}:

P_{Au-i}=P̅_̅{̅i̅n̅-̅A̅u̅-̅t̅}̅−P̅_̅{̅i̅n̅-̅S̅C̅}̅

Among them, P̅_̅{̅i̅n̅-̅A̅u̅-̅i̅}̅ represent the power mean value of the power set D_{Au-i} of CNC machine tool during the operation of the i (1≤i≤N_{Au}) auxiliary system.

The discrete function of startup time and startup energy consumption of CNC machine tool spindle system C_{S-PS};

$${C}_{S - P S} = [ \begin{matrix}n & {t}_{S - PS} & {E}_{S - P S}\end{matrix} ] = [ \begin{matrix}{ns}_{S - tr} [ 1 ] & {t}_{S - PS} [ 1 ] & {E}_{S - P S} [ 1 ] \\ ⋮ & ⋮ & ⋮ \\ {ns}_{S - tr} [ i ] & {t}_{S - PS} [ i ] & {E}_{S - P S} [ i ] \\ ⋮ & ⋮ & ⋮ \\ {ns}_{S - tr} [ 2 {N}_{tr} ] & {t}_{S - PS} [ 2 {N}_{tr} ] & {E}_{S - P S} [ 2 {N}_{tr} ]\end{matrix} ]$$

Where n represents the spindle speed, which is the independent variable; Both t_{S-PS} and E_{S-PS} are dependent variables, which are the starting time of the spindle system and the energy consumption of the spindle system. The t_{S-PS} [i] is the running time of the power set D_{PS-i} in the starting process of the i (1≤i≤2Nₜᵣ) spindle speed of CNC machine tool. The calculation formula E_{S-PS}[i] is as follows:

E_{S-PS}[i]=E_{in-PS}[i]−P̅_̅{̅i̅n̅-̅S̅C̅}̅t_{S-PS}[i]

Among them, E_{in-PS}[i] is the set energy consumption of the power set D_{PS-i} of the CNC machine tool during the starting process of the i (1≤i≤2Nₜᵣ) spindle speed.

The idling power discrete function of the spindle system of CNC machine tool in the idling period is C_{S-US}:

$${C}_{S - US} = [ \begin{matrix}n & {P}_{S - US}\end{matrix} ] = [ \begin{matrix}{ns}_{S - tr} [ 1 ] & {P}_{S - US} [ 1 ] \\ ⋮ & ⋮ \\ {ns}_{S - tr} [ i ] & {P}_{S - US} [ i ] \\ ⋮ & ⋮ \\ {ns}_{S - tr} [ 2 {N}_{tr} ] & {P}_{S - US} [ 2 {N}_{tr} ]\end{matrix} ]$$

Where n represents the spindle speed, which is the independent variable; P_{S-the US} represents the power function of the spindle system in the air operation process as the dependent variable; The calculation power formula of P_{S-US}[i] is as follows:

P_{S-US}[i]=P̅_̅{̅i̅n̅-̅U̅S̅}̅−P̅_̅{̅i̅n̅-̅S̅C̅}̅

Where P_{in-US}[i] is the mean power of the power set D_{US-i} of the CNC machine tool in the i (1≤i≤2Nₜᵣ) spindle speed empty operation process.

The discrete function C_{I-PF}(I∈[X, Y, Z], X, Y, Z denotes the X-axis, Y-axis, and Z-axis of the machine tool respectively) of the feed axis system of the CNC machine tool in the process of rapid feed&return:

$${C}_{I - PF} = [ \begin{matrix}{d}_{I - tr} & {t}_{I - PF} & {E}_{I - PS}\end{matrix} ] = [ \begin{matrix}{d}_{I - tr} [ 1 ] & {t}_{I - PF} [ 1 ] & {E}_{I - PS} [ 1 ] \\ ⋮ & ⋮ & ⋮ \\ {d}_{I - tr} [ i ] & {t}_{I - PF} [ i ] & {E}_{I - PS} [ i ] \\ ⋮ & ⋮ & ⋮ \\ {d}_{I - tr} [ {N}_{tr} ] & {t}_{I - PF} [ {N}_{tr} ] & {E}_{I - PS} [ {N}_{tr} ]\end{matrix} ]$$

Among them, d_{I-tr} represents rapid feed&return distance as independent variables; t_{I-PF} and E_{I-PF} are dependent variables, t_{I-PF} means rapid feed&return time, E_{I-PF} means rapid feed&return energy consumption; t_{I-PF}[i] is the running time of feed axis I (I∈[X, Y, Z]) in the power set D_{I-PF-i} with i^{th} (1≤i≤Nₜᵣ) rapid feed&return distance in rapid feed&return process; The calculation formula of E_{I-FF}[i] is as follows:

E_{I-FF}[i]=E_{in-I-PF}[i]−P̅_̅{̅i̅n̅-̅S̅C̅}̅t_{I-PF}[i];

In the formula, E_{in-I-PF}[i] is the set energy consumption of the power set D_{I-PF-i} of the feed axis I (I∈[X, Y, Z]) with the i^{th}(1≤i≤Nₜᵣ) fast forward fast-backward distance in the fast forward fast-backward process.

The discrete function C_{I-UF} of feed power in the cutting feed operation process of the CNC machine tool feed shaft system is:

$${C}_{I - UF} = [ \begin{matrix}{cv}_{I - TR} & {P}_{I - UF}\end{matrix} ] = [ \begin{matrix}{cv}_{I - TR} [ 1 ] & {P}_{I - UF} [ 1 ] \\ ⋮ & ⋮ \\ {cv}_{I - TR} [ i ] & {P}_{I - UF} [ i ] \\ ⋮ & ⋮ \\ {cv}_{I - TR} [ {N}_{tr} ] & {P}_{I - UF} [ {N}_{tr} ]\end{matrix} ]$$

Where cv_{I-tr} represents the cutting feed rate of I axis, which is the independent variable; P_{I-UF} represents the feed power of I-axis cutting as the dependent variable;

The calculation formula of P_{I-UF}[i] is as follows:

P_{I-UF}[i]=P̅_̅{̅i̅n̅-̅I̅-̅U̅F̅}̅[i]−P̅_̅{̅i̅n̅-̅S̅C̅}̅

In the formula, P_{in-I-UF}[i] is the mean power of D_{I-UF-i} is the power set of the CNC machine tool in the feed axis I (I∈[X, Y, Z]) cutting feed process at the i (1≤i≤Nₜᵣ) cutting speed.

The discrete function C_{PT} of the tool changing time and energy consumption of the CNC tool changing system during the tool changing operation is:

$${C}_{P T} = [ \begin{matrix}{n}_{t} & {t}_{PT} & {E}_{P T}\end{matrix} ] = [ \begin{matrix}1 & {t}_{PT} [ 1 ] & {E}_{PT} [ 1 ] \\ ⋮ & ⋮ & ⋮ \\ {n}_{t} & {t}_{PT} [ {n}_{t} ] & {E}_{PT} [ {n}_{t} ] \\ ⋮ & ⋮ & ⋮ \\ {N}_{t} & {t}_{PT} [ {N}_{tr} ] & {E}_{PT} [ {N}_{tr} ]\end{matrix} ]$$

Where nₜ represents the tool change position, which is the independent variable; t_{PT} and E_{PT} are dependent variables, t_{PT} means tool change time, E_{PT} means tool change energy consumption of tool changing system; t_{PT}[nₜ] is the running time for the power set D_{PT-nt} of the tool process of the automatic tool changing system for the nₜ^{th} (1≤nₜ≤Nₜ) tool position; The calculation formula of E_{PT}[nₜ] is as follows:

E_{PT}[nₜ]=E_{in-PT}[nₜ]−P̅_̅{̅i̅n̅-̅S̅C̅}̅t_{PT}[nₜ]

In the expression, E_{in-PT}[nₜ] is the set energy consumption of the power set D_{PT-n}_{ₜ} of the tool process of the automatic tool changing system for the nₜ^{th} (1≤nₜ≤Nₜ) tool position.

The discrete function of inherent energy efficiency factors can be transformed into tabular form to facilitate the calculation and query of inherent energy efficiency factors. For example, the discrete function of inherent energy efficiency factors C_{S-PS} for the spindle system startup process and air operation process of the vertical CNC milling center XK714D in this specific implementation method is transformed into the following table 10:

TABLE 10
The discrete function C_{S - PS} of inherent energy efficiency
factors in the starting process of CNC machine tool spindle system

| | Rotational speed(r/min) | | | | | | | | | |
|---|---|---|---|---|---|---|---|---|---|---|
| | 250 | 300 | 350 | 400 | 450 | 500 | 550 | 600 | 650 | 700 |
| Duration(s) | 0.75 | 0.75 | 0.75 | 0.75 | 0.8 | 0.8 | 0.8 | 0.8 | 0.8 | 0.8 |
| Energy | 307 | 390 | 412 | 468 | 603 | 692 | 690 | 801 | 817 | 831 |
| consumption(J) | | | | | | | | | | |

| | Rotational speed(r/min) | | | | | | | | | |
|---|---|---|---|---|---|---|---|---|---|---|
| | 750 | 1500 | 2250 | 3000 | 3750 | 4500 | 5250 | 6000 | 6750 | 7500 |
| Duration(s) | 0.8 | 0.85 | 0.90 | 0.95 | 1.15 | 1.35 | 1.75 | 2.15 | 2.6 | 3.4 |
| Energy | 967 | 1757 | 2615 | 3365 | 4703 | 6257 | 8249 | 10393 | 13089 | 16464 |
| consumption(J) | | | | | | | | | | |

Through the table, you can directly query the operating conditions for speed 250r/min, 300r/min, 350r/min . . . 7500r/min, the starting time t_{S-PS} and the starting energy consumption E_{S-PS} of the inherent energy efficiency factors in the spindle starting the process; For example, under the operating condition of 250 r/min rotational speed, the starting time of the spindle starting process is 0.75 s, and the starting energy consumption of the spindle starting process is 307 J. If it is necessary to calculate the inherent energy efficiency factors of the spindle system in the starting process of untested speed nᵤₙ, the two speeds n₊₁ and n₋₁ closest to nun are first found in the tested speed nun; Then, 0.5(E_{S-PS} (n₊₁)+E_{S-PS} (n₊₁)) is approximated to the start-up energy consumption corresponding to the unknown speed nun, and 0.5(t_{S-PS} (n₊₁)+t_{S-PS} (n₊ₗ)) is approximated to the start-up time corresponding to the unknown speed nun.

2) Discrete Modeling Method Combined with an Adaptive Fitting Modeling Method

Based on discrete modeling, the data analysis module uses the adaptive fitting modeling method to establish the inherent energy efficiency factor function of each energy consumption subsystem of CNC machine tool, comprising the following steps:

Step 2.3: The discrete function of each energy consumption subsystem of CNC machine tool established by discrete modeling method is regarded as a data set for fitting; Split the dataset into the training set and test set; 70% of the discrete data in the discrete function of the inherent energy efficiency factor can be used as the training set, and the rest as the test set;

Step 2.4: First fitting function and the second fitting function are fitted by the least square method according to the training set. The general formula of the first fitting function and the second fitting function is as follows:

$$y ( x , ω ) = {\sum }_{j = 0}^{q} {w}_{j} {x}^{j} , q = 1 , 2 ;$$

Step 2.5: Using the test set, the errors of the first fitting function, and the second fitting function are calculated according to the error function; The error function is as follows:

$$E ( ω ) = \frac{1}{2} {\sum }_{n = 1}^{N} {\{ y ( {x}_{n} , ω ) - {y}_{n} \}}^{2}$$

Step 2.6: If the error E(ω_{q}=1) of the first fitting function is smaller than that of the second fitting function E(ω_{q}=2), the first fitting function is selected as the function of the inherent energy efficiency factor; Otherwise, the quadratic fitting function is selected as the inherent energy efficiency factor function.

For the vertical CNC milling center XK714D, the inherent energy efficiency factor function of the CNC machine tool energy consumption subsystem obtained by the adaptive fitting modeling method is as follows:

The spindle system of CNC machine tool: starting time fitting function t_{S-PS} (n), starting energy consumption fitting function E_{S-PS} (n), and air power fitting function P_{S-US} (n) with spindle speed n as independent variables;

$${t}_{S - PS} ( n ) = \{ \begin{matrix}0 .8 , 60 \leq n \leq 8000 \\ 7 \times 1 {0}^{- 8} {n}^{2} - 2 \times 1 {0}^{- 4} n + 1.02 , 750 \leq n \leq 8000 , ( {R}^{2} = 0.995 )\end{matrix} \\ {E}_{S - PS} ( n ) = \{ \begin{matrix}9 \times 1 {0}^{- 4} {n}^{2} + 2.16 n - 192 , 60 < n < 7 \; 50 , ( {R}^{2} = 0.973 ) \\ 3 \times 1 {0}^{- 4} {n}^{2} - 0.15 n + 1205 , 750 \leq n \leq 80 \; 00 , ( {R}^{2} = 0.999 )\end{matrix} \\ {E}_{S - US} ( n ) = \{ \begin{matrix}2 \times 1 {0}^{- 1} {n}^{2} - 0.063 n + 113 , 60 < n < 7 \; 50 , ( {R}^{2} = 0.973 ) \\ 4 \times 1 {0}^{- 6} {n}^{2} + 0.0176 n + 222 , 750 \leq n \leq 80 \; 00 , ( {R}^{2} = 0.962 )\end{matrix}$$

CNC machine tool feed axis system: The fitting function t_{I-PF}(d_{I}) of rapid feed&return time length of X-axis, Y-axis, and Z-axis of CNC machine tool with the rapid feed&return distance d_{I} as the independent variable, rapid feed&return energy consumption fitting function E_{I-PF}(d_{I}); The following I∈[X, Y, Z], X, Y, Z represent the X-axis, Y-axis, and Z-axis of the machine tool respectively.

When the ratio is 100%, the fitting results of the test experiment are as follows: X-axis rapid feed&return energy consumption fitting function E_{X-PF}(d_{X}) and rapid feed&return time fitting function t_{X-PF}(d_{X}), Y-axis forward and fast backward energy consumption fitting function E_{Y-PF}(d_{Y}) and rapid feed&return time fitting function t_{Y-PF} (d_{Y}), Z-axis rapid feed&return energy consumption fitting function E_{Z-PF}(d_{Z}) and rapid feed&return time fitting function t_{Z-PF}(d_{Z}).

$${E}_{X - P F} ( {d}_{X} ) = \{ \begin{matrix}0.8345 {d}_{X} + 29 , positive direction ( {R}^{2} = 0.9 \; 89 ) \\ 0.7299 {d}_{X} + 28 , negative direction ( {R}^{2} = 0.9 \; 90 )\end{matrix} ; \\ {t}_{X - F F} ( {d}_{X} ) = \{ \begin{matrix}3 \times 1 {0}^{- 3} {d}_{X} + 0.06 , positive direction ( {R}^{2} = 0.993 ) \\ 2.8 \times 1 {0}^{- 3} {d}_{X} + 0.05 , negative direction ( {R}^{2} = 0.979 )\end{matrix} ; \\ {E}_{Y - F F} ( {d}_{Y} ) = \{ \begin{matrix}- 2.5 \times 1 {0}^{- 3} {d}_{Y}^{2} + 1.3195 {d}_{Y} + 3 , positive direction ( {R}^{2} = 0.9 \; 89 ) \\ - 3.6 \times 1 {0}^{- 3} {d}_{Y}^{2} + 1.6404 {d}_{Y} - 8 , positive direction ( {R}^{2} = 0.9 \; 79 )\end{matrix} ; \\ {t}_{Y - F F} ( {d}_{Y} ) = \{ \begin{matrix}2.6 \times 1 {0}^{- 3} {d}_{Y} + 0.09 , positive direction ( {R}^{2} = 0.9 \; 93 ) \\ 2.7 \times 1 {0}^{- 3} {d}_{Y} + 0.07 , negative direction ( {R}^{2} = 0.9 \; 88 )\end{matrix} ; \\ {E}_{Z - F F} ( {d}_{Z} ) = \{ \begin{matrix}1.2015 {d}_{Z} + 11 , positive direction ( {R}^{2} = 0.993 ) \\ 0.4376 {d}_{Z} + 15 , negative direction ( {R}^{2} = 0.990 )\end{matrix} ; \\ {t}_{Z - P F} ( {d}_{Y} ) = \{ \begin{matrix}3.5 \times 1 {0}^{- 3} {d}_{Z} + 0.11 , positive direction ( {R}^{2} = 0.995 ) \\ 7 \times 1 {0}^{- 6} {d}_{Z}^{2} + 2.4 \times 1 {0}^{- 3} {d}_{Z} + 0.07 , negative direction ( {R}^{2} = 0.985 )\end{matrix} ;$$

When the ratio is 50%, the fitting results of the test experiment are as follows: X-axis fast forward fast-backward energy consumption fitting function E_{X-PF}(d_{X}) and fast forward fast-backward time fitting function t_{X-PF}(d_{X}), Y-axis fast forward fast-backward energy consumption fitting function E_{Y-PF}(d_{Y}) and fast forward fast-backward time fitting function t_{Y-PF}(d_{Y}), Z-axis fast forward fast-backward energy consumption fitting function E_{Z-PF}(d_{Z}) and fast forward fast-backward time fitting function t_{Z-PF}(d_{Z}).

$${E}_{X - P F} ( {d}_{X} ) = \{ \begin{matrix}0.8263 {d}_{X} + 8 , positive direction ( {R}^{2} = 0.998 ) \\ 0.7469 {d}_{X} + 7 , negative direction ( {R}^{2} = 0.998 )\end{matrix} \\ {t}_{X - PF} ( {d}_{X} ) = \{ \begin{matrix}5.8 \times 1 {0}^{- 3} {d}_{X} + 0.07 , positive direction ( {R}^{2} = 0.998 ) \\ 6.1 \times 1 {0}^{- 3} {d}_{X} + 0.01 , negative direction ( {R}^{2} = 0.996 )\end{matrix} \\ {E}_{Y - P F} ( {d}_{Y} ) = \{ \begin{matrix}0.6961 {d}_{Y} + 4 , positive direction ( {R}^{2} = 0.994 ) \\ 0.7378 {d}_{Y} + 6 , positive direction ( {R}^{2} = 0.993 )\end{matrix} \\ {t}_{Y - PF} ( {d}_{Y} ) = \{ \begin{matrix}6.3 \times 1 {0}^{- 3} {d}_{Y} + 0.01 , positive direction ( {R}^{2} = 0.992 ) \\ 6.1 \times 1 {0}^{- 3} {d}_{Y} + 0.03 , positive direction ( {R}^{2} = 0.992 )\end{matrix} \\ {E}_{Z - PF} ( {d}_{Z} ) = \{ \begin{matrix}1.4358 {d}_{Z} + 3 , positive direction ( {R}^{2} = 0.998 ) \\ 0.2869 {d}_{Z} + 7 , negative direction ( {R}^{2} = 0.987 )\end{matrix} \\ {t}_{Z - P F} ( {d}_{Z} ) = \{ \begin{matrix}8.1 \times 1 {0}^{- 3} {d}_{Z} + 0.08 , positive direction ( {R}^{2} = 0.997 ) \\ 8.2 \times 1 {0}^{- 3} {d}_{Z} + 0.01 , negative direction ( {R}^{2} = 0.998 )\end{matrix}$$

CNC machine tool feed axis system: cutting feed power fitting function P_{I-UF}(cv_{I}) with cutting feed speed cv_{I} as the independent variable; where the subscript I∈[X, Y, Z], and X, Y, Z represent the X-axis, Y-axis, and Z-axis of the machine tool, respectively.

$${P}_{X - U F} ( c {v}_{X} ) = \{ \begin{matrix}0.0109 c {v}_{X} + 20 , positive direction ( {R}^{2} = 0.997 ) \\ 0.0098 c {v}_{X} , negative direction ( {R}^{2} = 0.994 )\end{matrix} \\ {P}_{Y - U F} ( c {v}_{Y} ) = \{ \begin{matrix}0.0107 c {v}_{Y} , positive direction ( {R}^{2} = 0.977 ) \\ 0.0115 c {v}_{Y} + 4 , negative direction ( {R}^{2} = 0.979 )\end{matrix} \\ {P}_{Z - U F} ( c {v}_{Z} ) = \{ \begin{matrix}0.0212 c {v}_{Z} + 22 , positive direction ( {R}^{2} = 0.996 ) \\ 0.0048 c {v}_{Z} + 3 , negative direction ( {R}^{2} = 0.965 )\end{matrix}$$

Automatic tool changing system for CNC machine tool: tool change time fitting function t_{PT}(nₜ) and tool change energy consumption fitting function E_{PT}(nₜ) with tool change data n t as independent variables.

$${t}_{P T} ( {n}_{t} ) = \{ \begin{matrix}1.257 {n}_{t} + 8.9 , positive rotations ( {R}^{2} = 0.999 ) \\ 1.2 {n}_{t} + 9.2 , negative rotations ( {R}^{2} = 0.999 )\end{matrix} \\ {E}_{PT} ( {n}_{t} ) = \{ \begin{matrix}130 {n}_{t} + 2424 , positive rotations ( {R}^{2} = 0.984 ) \\ 229 {n}_{t} + 2179 , negative rotations ( {R}^{2} = 0.987 )\end{matrix}$$

Step 8: Data analysis module establishes the inherent energy efficiency factor function of CNC machine tool in each operation stage according to the inherent energy efficiency factor function of each energy consumption subsystem in step 7;

Power function of CNC machine tool in the standby stage P_{in-S}(s_{Cs}):

P_{in-PA}(s_{cf},s_{ct})=250s_{Cs}270;

The power function P_{in-PA}(s_{cf},s_{ct}) of CNC machine tool in the opening stage of the auxiliary system:

P_{in-PA}(s_{cf},s_{ct})=530+220s_{cf}+170s_{ct};

Among them, s_{cf} indicates the state of the cutting fluid system, s_{cf}=0 indicates that the cutting fluid system is closed, and s_{cf}=1 indicates that the cutting fluid system is open. s_{ct} means the state of the chip transport system, s_{ct}=0 means the chip transport system is closed, s_{ct}=1 means the chip transport system is open; Besides, the opening and closing of compressed air systems do not result in significant power consumption, which is omitted.

Energy Consumption Function of CNC Machine Tool in Starting Stage of Spindle System E_{in-PS}(n, s_{cf}, s_{ct}):

E_{in-PS}(n,s_{cf},s_{ct}):=(530+220s_{cf}+170s_{ct})t_{S-PS}(n)+E_{S-PS}(n);

Energy Consumption Function of CNC machine tool in the Stage of Fast Forward and Backward E_{in-PF}(d_{I},s_{cf},s_{ct}):

E_{in-PF}(d_{I},s_{cf},s_{ct})=(530+220s_{cf}+170s_{ct})Σt_{I-PF}(d_{I})+ΣE_{I-PF}(d_{I});

Energy Consumption Function of CNC Machine Tool in Tool Changing Stage E_{in-PT}(nₜ,s_{cf},s_{ct}):

E_{in-PT}(nₜ,s_{cf},s_{ct})=(530+220s_{cf}+170s_{ct})t_{PT}(nₜ)+E_{PT}(nₜ);

Power function of CNC machine tool in the idling stage P_{in-U}(n,cv_{I},s_{cf},s_{ct}):

P_{in-U}(n,cv_{I},s_{cf},s_{ct})=530+220s_{cf}+170s_{ct}+P_{S-US}(n)+ΣP_{I-UF}(cv_{I}),

Step 9: Validity verification of the inherent energy efficiency factor function of CNC machine tool generated by the data analysis module is carried out through the validity verification module. If the inherent energy efficiency factor function passes the validity verification, step B10 is entered. If the inherent energy efficiency factor function fails to pass the validity verification, then repeat step B1 to step B9. If it still fails to pass the validity verification of the function, contact technical personnel to eliminate the problem.

In the process of validity verification, the data analysis module calculates the verification value of the inherent energy efficiency factor according to the general formula in Step 2.1, comprising the verification power P̅_̅{̅i̅n̅-̅S̅C̅-̅V̅}̅ in the operation stage of the numerical control system, the verification power P̅_̅{̅i̅n̅-̅A̅u̅-̅V̅}̅ in the whole operation stage of the auxiliary system, the verification energy consumption E_{in-PS-V} in the startup stage of the spindle system, the verification power P̅_̅{̅i̅n̅-̅U̅S̅-̅V̅}̅ in the empty operation stage of the spindle system, the verification energy consumption E_{in-I-PF-V} in the rapid feed&return stage of the feed shaft I (I∈[X, Y, Z]), the verification power P̅_̅{̅i̅n̅-̅U̅S̅-̅V̅}̅ the cutting feed stage of the feed shaft I (I∈[X, Y, Z]), and the verification energy consumption E_{in-PT-V} in the tool changing stage of the automatic tool changing system.

Among them, P̅_̅{̅i̅n̅-̅S̅C̅-̅V̅}̅ is to verify the average power of the power set D_{SC-V} in the experiment; P̅_̅{̅i̅n̅-̅A̅u̅-̅V̅}̅ is to verify the average power of the power set D_{Au-V} in the experiment; E_{in-PS-V} is the set energy consumption of the power set D_{PS-V} in the verification experiment; P̅_̅{̅i̅n̅-̅U̅S̅-̅V̅}̅ is to verify the average power of the power set D_{US-V} in the experiment; E_{in-I-PF-V} is the set energy consumption of the power set D_{I-PF-V} in the verification experiment (I∈[X, Y, Z]); P̅_̅{̅i̅n̅-̅U̅S̅-̅V̅}̅ is the mean power of the power set D_{I-UF-V} in the verification experiment (I∈[X, Y, Z]); E_{in_PT-V} is the set energy consumption of the power set D_{PT-V} in the verification experiment.

The data analysis module calculates the predicted values of the inherent energy efficiency factors under the verification experimental conditions according to the operation conditions of the verification experiment and the inherent energy efficiency factor function of the CNC machine tool, comprising the predicted power P_{in-S}(s_{Cs}=1) in the operation stage of the CNC system, the predicted power P_{in-PA}(s_{Au-i}=1) in the whole operation stage of the auxiliary system, the predicted energy consumption E_{in-PS}(n=n_{V},s_{Au-i}=1) in the start stage of the spindle system, the predicted power P_{in-U}(n=n_{V},cv_{I}=0,s_{Au-i}=1) in the rapid feed&return stage of the feed shaft I (I∈[X, Y, Z]), and the predicted power P_{in-U}(n=0,cv_{I}=cv_{I-V},s_{Au-i}=1) in the cutting feed stage of the feed shaft I (I∈[X, Y, Z]), and the predicted energy consumption E_{in-PT}(nₜ=n_{t-V},s_{Au-i}=1) in the tool changing stage.

The relative error value is used to verify the effectiveness of the detected inherent energy efficiency elements of CNC machine tool in the standby operation process, the operation process of the auxiliary system, the startup process of the spindle system under the specified speed, the empty operation process of the spindle system under the specified speed, the feed shaft system in the specified fast feed and fast retreat process, the feed shaft system in the specified cutting feed process and the automatic tool changing system in the specified tool change process. If the relative error is within 5%, it can be regarded as a pass. The verification results of this specific implementation method are as follows:

TABLE 10
Validation Table

| | | Appointed | Verification | | Acquiring | | | |
|---|---|---|---|---|---|---|---|---|
| | | parameters of | value of | | system | | | |
| Awaiting proved | | validation | verification | | predictive | | Relative | Effective or |
| stage | | experimental | experiment | | value | | error | not |
| Standby stage | | s_{Cs} = 1 | 528 | W | 520 | W | −1.52% | effective |
| Auxiliary system | | s_{cf} = 1, s_{ct} = 1 | 918 | W | 910 | W | −0.87% | effective |
| operation phase | | | | | | | | |
| Starting stage of the | | ^{S}_{cf} = 1, s_{ct} = 1 | 925 | J | 928 | J | 0.32% | effective |
| spindle system | | nᵥ = 750 r/min | | | | | | |
| Running open stage of | | s_{cf} = 1, s_{ct} = 1 | 1114 | W | 1110 | W | −0.36% | effective |
| spindle system | | nᵥ = 750 r/min | | | | | | |
| | | cv_{I} = 0 | | | | | | |
| Fast forward and | X-axis | s_{cf} = 1, s_{ct} = 1 | 611 | J | 609 | J | −0.33% | effective |
| backward | | d_{X - v} = 150 mm | | | | | | |
| stage of feed | Y-axis | s_{cf} = 1, s_{ct} = 1 | 426 | J | 421 | J | −0.17% | effective |
| shaft system | | d_{Y - v} = 100 mm | | | | | | |
| | Z-axis | s_{cf} = 1, s_{ct} = 1 | 532 | J | 539 | J | 1.32% | effective |
| | | d_{Z - v} = 100 mm | | | | | | |
| The cutting feed | X-axis | s_{cf} = 1, s_{ct} = 1 | 997 | W | 986 | W | −1.10% | effective |
| stage of feed | | cv_{X - v} = 5000 mm/min | | | | | | |
| shaft system | Y-axis | s_{cf} = 1, s_{ct} = 1 | 997 | W | 986 | W | −1.10% | effective |
| | | cv_{Y - v} = 5000 mm/min | | | | | | |
| | Z-axis | s_{cf} = 1, s_{ct} = 1 | 956 | W | 962 | W | 0.63% | effective |
| | | cv_{Z - v} = 5000 mm/min | | | | | | |

| | | | | | | | |
|---|---|---|---|---|---|---|---|
| Tool changing stage of | s_{cf} = 1, s_{ct} = 1 | 18228 | J | 18275 | J | 0.26% | effective |
| tool changing system | n_{t - v} = 6 | | | | | | |

It can be seen from Table 10 that the relative errors are all less than 5%. The inherent energy efficiency factor function (discrete modeling method combined with an adaptive fitting modeling method) of the specific implementation method has passed the validity verification. Therefore, the inherent energy efficiency factor function that has passed the validity verification can be used to calculate the inherent energy efficiency factor under the specified operating conditions, and step 10 can be entered.

Step 10: According to the inherent energy efficiency factor function of CNC machine tool in each operation process and the operating conditions of CNC machine tool, the inherent energy efficiency factors in each operation process of CNC machine tool are calculated.

According to the inherent energy efficiency factor function of each energy consumption subsystem in the test experiment and the operating conditions of each energy consumption subsystem in the test experiment, the inherent energy efficiency factors of each energy consumption subsystem in different operating conditions and different operating processes are calculated, to obtain the inherent energy efficiency factors of CNC machine tool to be tested. Operating conditions are composed of operating parameters, comprising the following operating parameters: CNC system operating state s_{Cs}, spindle speed n, feed shaft fast feed fast retreat distance d_{I}, feed shaft cutting speed cv_{I}, tool change position nₜ, the auxiliary system operating state s_{Au-i}.

What is claimed is:

1. A system for acquiring an inherent energy efficiency factor function of a computerized numerically controlled (CNC) machine tool, wherein the CNC machine tool comprises the following energy consumption subsystems: a CNC system, a spindle system, a feed shaft system, an automatic tool changing system and an auxiliary system, the system comprises: an equipment information management module, a test parameter setting module, a numerically controlled (NC) code generation module, a field test management module, a data analysis module and power sensors configured to install on the CNC machine tool to be tested and obtain the power data of the CNC machine tool to be tested;
the equipment information management module is configured to input the basic information, spindle system information, feed shaft system information, automatic tool automatic tool changing system information and auxiliary system information of the CNC machine tool to be tested;
the test parameter setting module is configured to set test parameters comprising a state-running duration tₒ, a state-switching-mark duration t_{d}, a state-switching-delay duration t_{dc}, number of training samples Nₜᵣ and an initial distance of a feed shaft d_{I-o};
the NC code generation module is configured to generate NC codes to control a operation according to the test parameters and the basic information, the spindle system information, the feed shaft system information, the tool automatic tool changing system information and the auxiliary system information of the NC machine tool to be tested, the NC codes comprises NC codes configured to control the spindle system running in a test process, NC codes configured to control the feed shaft system running in the test process, the NC codes configured to control the automatic tool changing system running in the test process and NC codes configured to control the auxiliary system running in the test process;
the field test management module is configured to set parameters of the power sensors, read power data information of the power sensors, parse power data information of the power sensors and generate power set;
the data analysis module is configured to generate an inherent energy efficiency factor function of each energy consumption subsystem according to the power set of the CNC machine tool to be tested during the test operation, and generate an inherent energy efficiency factor function of each operation stage of the CNC machine tool according to the inherent energy efficiency factor function of each energy consumption subsystem.

2. The system as claimed in claim 1, wherein the basic information comprises a machine type, a machine model, and a CNC system type, the spindle system information comprises a maximum spindle speed n_{S-max}, a minimum spindle speed n_{S-min}, a rated spindle speed n_{S-r}, a speed interval ΔS-n-u above a rated speed and a speed interval ΔS-n-l below the rated speed, the feed axis system information comprises a fast feed speed fv_{I-max} in a direction of I axis, a axial stroke d_{I}, and a maximum cutting feed speed cv_{I-max}, the subscript I∈[X, Y, Z], X, Y, Z represent a X-axis, a Y-axis, and a Z-axis of the machine tool respectively, the automatic tool automatic tool changing system information comprises the number of tool positions in a tool library Nₜ, the auxiliary system information comprises a total number of auxiliary systems controlled by the CNC system N_{Au}, a name of each auxiliary system, and a start-stop control code of each auxiliary system.

3. The system as claimed in claim 2, wherein the NC codes configured to control the operation of the spindle system in the test process comprises the spindle starting speed setting code, and a total number of spindle speed test is 2 Nₜᵣ, and the i-th spindle speed ns_{S-tr}[i] is set according to a following formula:
$${ns}_{S - tr} [ i ] = \{ \begin{matrix}{n}_{S - r} - {Δ}_{S - n - i} ⌊ \frac{{n}_{S - min} - {n}_{s - r}}{{N}_{t r} {Δ}_{S - n - l}} ⌋ ( i - {N}_{t r} ) , 0 \leq i < {N}_{t r} \\ {n}_{S - r} + {Δ}_{S - n - u} ⌊ \frac{{n}_{S - max} - {n}_{S - r}}{{N}_{t r} {Δ}_{S - n - u}} ⌋ ( i - {N}_{t r} ) , {N}_{t r} \leq i \leq 2 {N}_{t r}\end{matrix} ,$$
and [ ] represents the integer operation;
the NC codes configured to control the running of the feed shaft system in the test process comprises a rapid feed&return distance setting code, a total number of rapid feed&return distance tests is Nₜᵣ, and the i-th rapid feed&return distance d_{I-tr}[i] is set according to a following formula:
$${d}_{I - tr} [ i ] = {d}_{I - o} + \frac{{d}_{I} - 2 {d}_{I - o}}{{N}_{t r}} i ,$$
and 1≤i≤Nₜᵣ, d_{I} is a axial travel of the feed shaft in a direction of I axis, d_{I-o} represents an initial distance of the feed shaft in the direction of I axis;
the NC codes configured to control the feed shaft system in the test process also comprises a cutting feed speed setting code, the total number of cutting feed rate tests is Nₜᵣ, and the i-th cutting feed rate cv_{I-tr}[i] is set according to a following formula:
$$c {v}_{I - tr} [ i ] = \frac{{cv}_{I = max}}{{N}_{t r}} i ,$$
and 1≤i≤Nₜᵣ, cv_{I-max} represents a maximum cutting feed rate in the I-axis direction.

4. The system as claimed in claim 2, wherein the power set generated by the field test management module according to the power data information collected by the power sensors in the test process of CNC machine tool comprises: an input power set of the CNC machine tool in a power supply opening process D_{SP}; an input power set of the CNC machine tool in a CNC system operation process D_{SC}; the input power set D_{Au-i} of the CNC machine tool during an operation of an i-th auxiliary system, 1≤i≤N_{Au}; the input power set D_{PS-i} of the CNC machine tool, in a start-up process of an i-th spindle speed, 1≤i≤2Nₜᵣ; an input power set D_{US-i} of the CNC machine tool in a process of an i-th spindle speed empty operation; an input power set D_{I-PF-i} of the CNC machine tool in a process of an i-th rapid feed&return distance in the feed shaft I, 1≤i≤Nₜᵣ; an input power set D_{I-UF-i} of the CNC machine tool in a feed axis I cutting a feed process at an i-th cutting speed, 1≤i≤Nₜᵣ; an input power set D_{PT-n}_{ₜ} of the CNC machine tool in a process of changing an nₜ-th tool position by the automatic tool changing system.

5. The system as claimed in claim 1, wherein the data analysis module is configured to establish an inherent energy efficiency factor discrete function of each energy consumption subsystem of the CNC machine tool by a discrete modeling method, comprising following steps:
step 2.1: calculating a power mean P̅_̅{̅D̅}̅, a set time t_{D} and a set energy consumption E_{D} for each power set, according to following general formula:
$$\overline{{P}_{D}} = \frac{1}{{N}_{D}} {\sum }_{k = 1}^{{N}_{D}} {P}_{k} , {P}_{k} ∈ D ; {t}_{D} = \frac{{N}_{D}}{f s} ; {E}_{D} = \frac{1}{f s} {\sum }_{k = 1}^{{N}_{D}} {P}_{k} , {P}_{k} ∈ D ,$$
wherein D represents the power set, Pₖ represents a k-th element in the power set D, N_{D} represents the number of elements in the power set D, and fs represents a sampling frequency of the power sensors;
step 2.2: setting up the inherent energy efficiency factor discrete function of each energy consumption subsystem of the CNC machine tool:
wherein a power consumption PSP of the CNC machine tool in a power supply opening process:
P_{SP}=P̅_̅{̅i̅n̅-̅S̅P̅}̅,
and P̅_̅{̅i̅n̅-̅S̅P̅}̅ represents a power average of the power set D_{SP} of the CNC machine tool in the power supply opening process,
a power consumption of a control system of the CNC machine tool P_{Cs}:
P_{Cs}=P̅_̅{̅i̅n̅-̅S̅C̅}̅−P_{SP},
and P̅_̅{̅i̅n̅-̅S̅C̅}̅ represents a power mean of the power set D_{SC} of the CNC machine tool in the operation process of the CNC system,
a power consumption of the auxiliary system P_{Au-i}:
P_{Au-i}=P̅_̅{̅i̅n̅-̅A̅u̅-̅i̅}̅−P̅_̅{̅i̅n̅-̅S̅C̅}̅,
and P̅_̅{̅i̅n̅-̅A̅u̅-̅t̅}̅ represents a power average of the power set D_{Au-i} of the CNC machine tool during the operation of the i-th auxiliary system, 1≤i≤N_{Au},
a discrete function of startup time and energy consumption of the spindle system is C_{S-PS}:
$${C}_{S - P S} = [ \begin{matrix}n & {t}_{S - PS} & {E}_{S - P S}\end{matrix} ] = [ \begin{matrix}n {s}_{S - t r} [ 1 ] & {t}_{S - P S} [ 1 ] & {E}_{S - P S} [ 1 ] \\ ⋮ & ⋮ & ⋮ \\ n {s}_{S - t r} [ i ] & {t}_{S - P S} [ i ] & {E}_{S - P S} [ i ] \\ ⋮ & ⋮ & ⋮ \\ {ns}_{S - tr} [ 2 {N}_{tr} ] & {t}_{S - PS} [ 2 {N}_{tr} ] & {E}_{S - PS} [ 2 {N}_{tr} ]\end{matrix} ]$$
and n represents a spindle speed and is an independent variable; both t_{S-PS} and E_{S-PS} are dependent variables, which are a starting time of the spindle system and a energy consumption of the spindle system. the t_{S-PS}[i] is a running time of the power set D_{PS-i} in the starting process of the CNC machine tool in the start-up process of the i-th spindle speed, 1≤i≤2 Nₜᵣ,
a calculation formula of E_{S-PS}[i] is as follows:
E_{S-PS}[i]=E_{in-PS}[i]−P̅_̅{̅i̅n̅-̅S̅C̅}̅t_{S-PS}[i],
and E_{S-PS}[i] is the set energy consumption of the power set D_{PS-i} of the CNC machine tool in a start-up process of an i-th spindle speed, 1≤i≤2 Nₜᵣ,
an idling power discrete function of the spindle system in a process of air operation C_{S-US}:
$${C}_{S - US} = [ \begin{matrix}n & {P}_{S - US}\end{matrix} ] = [ \begin{matrix}n {s}_{S - t r} [ 1 ] & {P}_{S - US} [ 1 ] \\ ⋮ & ⋮ \\ n {s}_{S - t r} [ i ] & {P}_{S - US} [ i ] \\ ⋮ & ⋮ \\ {ns}_{S - tr} [ 2 {N}_{tr} ] & {P}_{S - US} [ 2 {N}_{tr} ]\end{matrix} ] ,$$
and n represents the spindle speed and is the independent variable, P_{S-US} represents a power function of a spindle system in an air operation process as a dependent variable,
a calculation power formula of P_{S-US}[i] is as follows:
P_{S-US}[i]=P̅_̅{̅i̅n̅-̅U̅S̅}̅[i]−P̅_̅{̅i̅n̅-̅S̅C̅}̅,
and P_{in-US}[i] is a mean power of the power set D_{US-i} of the CNC machine tool in the process of the i-th spindle speed empty operation, 1≤i≤2 Nₜᵣ,
a discrete function C_{I-PF} of a rapid feed&return time and an energy consumption of the rapid feed&return of the feed shaft system of the CNC machine tool is:
$${C}_{I - P F} = [ \begin{matrix}{d}_{I - tr} & {t}_{I - P F} & {E}_{I - P F}\end{matrix} ] = [ \begin{matrix}{d}_{I t r} [ 1 ] & {t}_{I - P F} [ 1 ] & {E}_{I P F} [ 1 ] \\ ⋮ & ⋮ & ⋮ \\ {d}_{I t r} [ i ] & {t}_{I - P F} [ i ] & {E}_{I - PF} [ i ] \\ ⋮ & ⋮ & ⋮ \\ {d}_{I t r} [ {N}_{tr} ] & {t}_{I - P F} [ {N}_{t r} ] & {E}_{I - PF} [ {N}_{tr} ]\end{matrix} ] ,$$
and the subscripts I∈[X, Y, Z], X, Y, Z represent the X axis, the Y axis and the Z axis of the machine tool respectively, d_{I-tr} represents a rapid feed&return distance and is an independent variable, t_{I-PF} and E_{I-PF} are dependent variables, t_{I-PF} means a rapid feed&return time, E_{I-PF} means a rapid feed&return energy consumption, t_{I-PF}[i] is a running time of a feed axis I in the power set D_{I-PF-i} of the CNC machine tool in a process of an i-th rapid feed&return distance in the feed shaft I, 1≤i≤Nₜᵣ,
a calculation formula of E_{I-FF}[i] is as follows:
E_{I-FF}[i]=E_{in-I-PF}[i]−P̅_̅{̅i̅n̅-̅S̅C̅}̅t_{I-PF}[i],
and E_{in-I-PF}[i] is a set energy consumption of the power set D_{I-PF-i} of the CNC machine tool in a process of an i-th rapid feed&return distance in the feed shaft I, 1≤i≤Nₜᵣ,
a discrete function C_{I-UF} of feed power in a cutting feed operation process of the feed shaft system is:
$${C}_{I - UF} = [ \begin{matrix}{cv}_{I - tr} & {P}_{I - UF}\end{matrix} ] = [ \begin{matrix}{cv}_{I - tr} [ 1 ] & {P}_{I - UF} [ 1 ] \\ ⋮ & ⋮ \\ {cv}_{I - tr} [ i ] & {P}_{I - UF} [ i ] \\ ⋮ & ⋮ \\ {cv}_{I - tr} [ {N}_{tr} ] & {P}_{I - UF} [ {N}_{tr} ]\end{matrix} ] ,$$
and cv_{I-tr} represents a cutting feed rate of I axis, which is an independent variable, P_{I-UF} represents a feed power of I-axis cutting and is a dependent variable,
a calculation formula of P_{I-UF[i] is as follows:}
P_{I-UF}[i]=P̅_̅{̅i̅n̅-̅I̅-̅U̅F̅}̅[i]−P_{in-SC},
and P̅_̅{̅i̅n̅-̅I̅-̅U̅F̅}̅[i] is a mean power of the power set D_{I-UF-i} of the CNC machine tool in the feed axis I cutting the feed process at the i-th cutting speed, 1≤i≤Nₜᵣ,
a discrete function C_{PT} of a tool changing time and energy consumption of the automatic tool changing system during a tool changing operation is:
$${C}_{PT} = [ \begin{matrix}{n}_{t} & {t}_{PT} & {E}_{PT}\end{matrix} ] = [ \begin{matrix}1 & {t}_{PT} [ 1 ] & {E}_{PT} [ 1 ] \\ ⋮ & ⋮ & ⋮ \\ {n}_{t} & {t}_{PT} [ {n}_{t} ] & {E}_{PT} [ {n}_{t} ] \\ ⋮ & ⋮ & ⋮ \\ {N}_{t} & {t}_{PT} [ {N}_{t} ] & {E}_{PT} [ {N}_{t} ]\end{matrix} ] ,$$
and nᵢ represents a tool change position and is an independent variable, t_{PT} and E_{PT} are dependent variables, t_{PT} means a tool change time, E_{PT} means a tool change energy consumption of the tool changing system, t_{PT}[nₜ] is a running time for the power set D_{PT-nt} of the CNC machine tool in a process of changing an nₜ-th tool position by the automatic tool changing system,
a calculation formula of E_{PT}[nₜ] is as follows:
E_{PT}[nₜ]=E_{in-PT}[nₜ]−P̅_̅{̅i̅n̅-̅S̅C̅}̅t_{PT}[nₜ],
and E_{in-PT} [nₜ] is a set energy consumption of the power set D_{PT-n}_{ₜ} of the CNC machine tool in a process of changing an nₜ-th tool position by the automatic tool changing system, 1≤nₜ≤Nₜ.

6. The system as claimed in claim 5, wherein the data analysis module establishes an inherent energy efficiency factor fitting function of each energy consumption subsystem of CNC machine tool by adaptive fitting modeling method based on discrete modeling, comprising following steps:
step 2.3: regarding the inherent energy efficiency factor discrete function of each energy consumption subsystem of the CNC machine tool established by the discrete modeling method as a data set for fitting, and dividing the data set into a training set and a test set by a cross-validation method in machine learning;
step 2.4: fitting a first fitting function and a second fitting function by a least square method according to the training set;
step 2.5: by the test set, calculating errors of the first fitting function and the second fitting function according to an error function;
step 2.6: If the error of the first fitting function is less than the error of the second fitting function, selecting the first fitting function as the inherent energy efficiency factor function, otherwise, selecting the second fitting function as the inherent energy efficiency factor function;
therefore, establishing following fitting functions of each energy consumption subsystem:
the spindle system of CNC machine tool: a fitting function of a starting time length t_{S-PS}(n), a fitting function of a starting energy consumption E_{S-PS}(n) and a fitting function of an air operation power P_{S-US}(n) which are with the spindle speed n as the independent variable respectively;
the feed shaft system of CNC machine tool: a rapid feed&return time fitting function t_{I-PF}(d_{I}) which is with a rapid feed&return distance d_{I} as an independent variable, a rapid feed&return energy consumption fitting function E_{I-PF}(d_{I}) which is with the rapid feed&return distance d_{I} as the independent variable, a cutting feed power fitting function P_{I-UF}(cv_{I}) with a cutting feed rate cv_{I} as a independent variable;
the automatic tool changing system: a tool change time fitting function t_{PT}(nₜ) and a tool change energy consumption fitting function E_{PT}(nₜ) which are with the tool change position nₜ as an independent variable.

7. The system as claimed in claim 6, wherein the inherent energy efficiency factor functions of the CNC machine tool comprise a power function P_{in-S}(s_{Cs}) of the CNC machine tool in a standby stage, a power function P_{in-PA}(s_{Au-i}) of the CNC machine tool in an opening stage of the auxiliary system, an energy consumption function E_{in-PS}(n,s_{Au-i}) of the CNC machine tool in a starting stage of the spindle system, an energy consumption function E_{in-PF}(d_{I},s_{Au-i}) of the CNC machine tool in a rapid feed&return stage, an energy consumption function E_{in-PT}(nₜ,s_{Au-i}) of the CNC machine tool in an automatic tool change stage and a power function P_{in-U}(n,cv_{I},s_{Au-i}) of the CNC machine tool in an idling stage, specific expressions are as follows:
the power function P_{in-S}(s_{Cs}) of the CNC machine tool in the standby stage:
P_{in-S}(s_{Cs})=P_{SP}+s_{Cs}P_{Cs},
and P_{SP} represents a power consumption when a CNC machine tool power is turned on, and P_{Cs} represents a new power consumption when the CNC machine tool power is turned on, s_{Cs} means a state of the CNC system, s_{Cs}=0 means the state of the CNC system is closed, s_{Cs}=1 means the state of the CNC system is open;
the power function of the CNC machine tool in an opening stage of the auxiliary system P_{in-PA}(s_{Au-i}):
P_{in-PA}(s_{Au-i})P_{S}+Σs_{Au-i}P_{Au-i},
P_{S} represents a standby power of CNC machine tool, P_{S}=P_{in-S}(s_{Cs}=1); P_{Au-i} means a new machine tool power consumption when a first auxiliary system is opened, 1≤i≤N_{Au}; s_{Au-i} represents a state of the i-th auxiliary system, 1≤i≤N_{Au}, s_{Au-i}=0 represents a closed state of the i-th auxiliary system, and s_{Au-i}=1 represents an open state of the i-th auxiliary system;
the energy consumption function E_{in-PS}(n,s_{Au-i}) of CNC machine tool in the starting stage of the spindle system:
E_{in-PS}(n,s_{Au-t})=(P_{S}+Σs_{Au-t}P_{Au-t})t_{S-PS}(n)+E_{S-PS}(n),
and n denotes the spindle speed, t_{S-PS}(n) and E_{S-PS}(n) are a starting time function and an energy consumption function of the spindle system, respectively;
the energy consumption function E_{in-PF}(d_{I},s_{Au-i}) of CNC machine tool in the rapid feed&return stage:
E_{in-PF}(d_{I},s_{Au-i})=(P_{S}+Σs_{Au-i}P_{Au-i})Σt_{I-PF}(d_{I})+ΣE_{I-PF}(d_{I}),
and t_{PT}(nₜ) and E_{PT}(nₜ) represent the rapid feed&return time fitting function, the rapid feed&return energy consumption fitting function of I axis respectively;
the energy consumption function E_{in-PT}(nₜ,s_{Au-i}) of CNC machine tool in the automatic tool change stage:
E_{in-PT}(nₜ,s_{Au-i})=(P_{S}+Σs_{Au-i}P_{Au-i})t_{PT}(nₜ)+E_{PT}(nₜ),
and nₜ represents the number of cutter positions that need to be rotated during automatic tool change; t_{PT}(nₜ) and E_{PT}(nₜ) represents the tool change time fitting function and the tool change energy consumption fitting function of the automatic tool changing system respectively;
the power function P_{in-U}(n,cv_{I},s_{Au-i}) in the idling stage of the CNC machine tool:
P_{in-U}(n,cv_{I},s_{Au-t})=P_{S}+P_{S-US}(n)+Σs_{Au-i}P_{Au-i}+ΣP_{I-UF}(cv_{I}),
Where P_{S-US}(n) represents the a fitting function of an air operation power of the spindle system; cv_{I} represents the feed rate and P_{I-UF}(cv_{I}) represents the a cutting feed power fitting function of the I axis.

8. The system as claimed in claim 1, wherein the system comprises:
a validity verification module, configured to verify a effectiveness of the inherent energy efficiency factor function, an judge whether the inherent energy efficiency factor function is effective according to an error between a verification value and a predicted value,
wherein the verification value is obtained by a verification experiment, and the predicted value is calculated by the data analysis module according to operation conditions of a verification experiment and the inherent energy efficiency factor function of the CNC machine tool in each operation stage,
to carry out the verification experiment, the NC code generation module and the field test management module are improved as follows:
the NC code generation module is also configured to generate a NC code for a verification experiment test according to the test parameters and the basic information, the spindle system information, the feed shaft system information, the tool automatic tool changing system information, and the auxiliary system information, the NC code for the verification experiment test comprises a NC code for controlling the operation of the auxiliary system in the verification experiment, a NC code for controlling a starting and an empty operation of the spindle system according to a specified speed n_{S-V} in the verification experiment, a NC code for controlling the feed shaft system according to a specified rapid feed&return distance d_{I-V} and a specified cutting feed speed cv_{I-V} in the verification experiment, and a NC code for controlling the automatic tool changing system according to a specified tool position n_{t-V} in the verification experiment;
the power set generated by the field test management module according to the power data information collected by the power sensors in the verification experiment of the CNC machine tool comprises: an input power set D_{SC-V} of the CNC machine tool in an operation process of the CNC system, an input power set D_{Au-V} of the CNC machine tool in a whole operation process of the auxiliary system, an input power set D_{PS-V} of the CNC machine tool in the spindle system according to the specified speed n_{S-V}, an input power set D_{US-V} of the CNC machine tool in an empty operation process of the spindle system according to the specified speed n_{S-V}, an input power set D_{I-PF-V} of the CNC machine tool in the feed shaft I (I∈[X, Y, Z]) in the feed shaft d_{I-V}.

9. A method for obtaining an inherent energy efficiency factors of a CNC machine tool, comprising, establishing an inherent energy efficiency factor function of each energy consumption subsystem and an inherent energy efficiency factor function of each operation stage of a CNC machine tool by a system for acquiring an inherent energy efficiency factor function of a CNC machine tool according to claim 1, and calculating inherent energy efficiency factors of the CNC machine tool in different operation processes according to the inherent energy efficiency factor function of the CNC machine tool, specifically comprising the following steps:
step A1: equipment information management module inputting basic information, active system information, and auxiliary system information of the CNC machine tool to be tested;
step A2: setting test parameters in a test parameter setting module, wherein the test parameters comprise: a state-running duration tₒ, a state switching flag time t_{d}, a state-switching-delay duration t_{dc}, the number of test samples Nₜᵣ and an initial distance of a feed shaft d_{I-o};
step A3: generating NC codes of a test experiment in a NC code generation module according to the test parameters in step A2, the basic information, the spindle system information, the feed shaft system information, the tool automatic tool changing system information, and the auxiliary system information of the CNC machine tool in step A1;
step A4: setting power sensors parameters in a field test module, and inputting the NC codes of the test experiment into a CNC system of the CNC machine tool to be tested;
step A5: the CNC machine tool running the NC codes of the test experiment and controlling the CNC machine tool to be tested to run according to the NC codes of the test experiment, at the same time, collecting power data information of each energy consumption subsystem in the test experiment of the CNC machine tool to be tested by the power sensors installed on the CNC machine tool to be tested, generating a power set of each energy consumption subsystem in the test experiment by the field test management module according to the power data information collected by the power sensors;
step A6: a data analysis module establishing the inherent energy efficiency factor function of each energy consumption subsystem according to the power set in step A5;
step A7: the data analysis module establishing the inherent energy efficiency factor function of CNC machine tool in each operation stage according to the inherent energy efficiency factor function of each energy consumption subsystem in step A6;
step A8: according to the inherent energy efficiency factor function of CNC machine tool in each operation stage and operating conditions of CNC machine tool, calculating inherent energy efficiency factors in each operation stage of CNC machine tool.

10. A method for obtaining inherent energy efficiency factors of a CNC machine tool, comprising, establishing an inherent energy efficiency factor function of each energy consumption subsystem and an inherent energy efficiency factor function of each operation stage of a CNC machine tool by a system for acquiring an inherent energy efficiency factor function of a CNC machine tool according to claim 8, and calculating inherent energy efficiency factors of the CNC machine tool in different operation processes according to the inherent energy efficiency factor function of the CNC machine tool, specifically comprising the following steps:
step B1: equipment information management module inputting basic information, active system information, and auxiliary system information of the CNC machine tool to be tested;
step B2: setting test parameters in a test parameter setting module, wherein the test parameters comprise: a state-running duration tₒ, a state switching flag time t_{d}, a state-switching-delay duration t_{dc}, the number of test samples Nₜᵣ, and an initial distance of a feed shaft d_{I-o};
step B3: generating NC codes of a test experiment and NC codes of a verification experiment in a NC code generation module according to the test parameters in step B2, the basic information, the spindle system information, the feed shaft system information, the tool automatic tool changing system information, and the auxiliary system information of the CNC machine tool in step B1;
step B4: setting power sensors parameters in a field test module, and inputting the NC codes of the test experiment and the NC codes of the verification experiment into a CNC system of the CNC machine tool to be tested;
step B5: the CNC machine tool running the NC codes of the test experiment and controlling the CNC machine tool to be tested to run according to the NC codes of the test experiment, at the same time, collecting power data information of each energy consumption subsystem in the test experiment of the CNC machine tool to be tested by the power sensors installed on the CNC machine tool to be tested, generating a power set of each energy consumption subsystem in the test experiment by the field test management module according to the power data information collected by the power sensors;
step B6: the CNC machine tool running the NC codes of the verification experiment and controlling the CNC machine tool to be tested to run according to the NC codes of the verification experiment, at the same time, collecting power data information of each energy consumption subsystem in the test experiment of the CNC machine tool to be tested by the power sensors installed on the CNC machine tool to be tested, generating a power set of each energy consumption subsystem in the verification experiment by the field test management module according to the power data information collected by the power sensors;
step B7: a data analysis module establishing the inherent energy efficiency factor function of each energy consumption subsystem according to the power set of the test experiment in step B5;
step B8: the data analysis module establishing the inherent energy efficiency factor function of CNC machine tool in each operation stage according to the inherent energy efficiency factor function of each energy consumption subsystem in step A6;
step B9: a validity verification module carrying out a validity verification of the inherent energy efficiency factor function of the CNC machine tool generated by the data analysis module, if the inherent energy efficiency factor function passes the validity verification, Entering step B10. if the inherent energy efficiency factor function fails to pass the validity verification, repeating steps B1 to B9, if still fail to pass the validity verification, contact technical personnel to eliminate the problem;
step B10: according to the inherent energy efficiency factor function of CNC machine tool in each operation stage and operating conditions of CNC machine tool, calculating inherent energy efficiency factors in each operation stage of CNC machine tool.

11. The method as claimed in claim 9, wherein the basic information comprises a machine type, a machine model, and a CNC system type, the spindle system information comprises a maximum spindle speed n_{S-max}, a minimum spindle speed n_{S-min}, a rated spindle speed n_{S-r}, a speed interval ΔS-n-u above a rated speed and a speed interval ΔS-n-l below the rated speed, the feed axis system information comprises a fast feed speed fv_{I-max} in a direction of I axis, a axial stroke d_{I}, and a maximum cutting feed speed cv_{I-max}, the subscript I∈[X, Y, Z], X, Y, Z represent a X-axis, a Y-axis, and a Z-axis of the machine tool respectively, the automatic tool automatic tool changing system information comprises the number of tool positions in a tool library Nₜ, the auxiliary system information comprises a total number of auxiliary systems controlled by the CNC system N_{Au}, a name of each auxiliary system, and a start-stop control code of each auxiliary system.

12. The method as claimed in claim 11, wherein the NC codes configured to control the operation of the spindle system in the test process comprises the spindle starting speed setting code, and a total number of spindle speed test is 2 Nₜᵣ, and the i-th spindle speed ns_{S-tr}[i] is set according to a following formula:
$$n {s}_{S - t r} [ i ] = \{ \begin{matrix}{n}_{S - r} - {Δ}_{S - n - l} ⌊ \frac{{n}_{S - min} - {n}_{S - r}}{{N}_{t r} {Δ}_{S - n - l}} ⌋ ( i - {N}_{t r} ) , 0 \leq i < {N}_{t r} \\ {n}_{S - r} + {Δ}_{S - n - u} ⌊ \frac{{n}_{S - max} - {n}_{S - r}}{{N}_{t r} {Δ}_{S - n - u}} ⌋ ( i - {N}_{t r} ) , {N}_{t r} \leq i \leq 2 {N}_{t r}\end{matrix} ,$$
and [ ] represents the integer operation;
the NC codes configured to control the running of the feed shaft system in the test process comprises a rapid feed&return distance setting code, a total number of rapid feed&return distance tests is Nₜᵣ, and the i-th rapid feed&return distance d_{I-tr}[i] is set according to a following formula:
$${d}_{I - tr} [ i ] = {d}_{I - o} + \frac{{d}_{I} - 2 {d}_{I - o}}{{N}_{t r}} i ,$$
and 1≤i≤Nₜᵣ, d_{I} is a axial travel of the feed shaft in a direction of I axis, d_{I-o} represents an initial distance of the feed shaft in the direction of I axis;
the NC codes configured to control the feed shaft system in the test process also comprises a cutting feed speed setting code, the total number of cutting feed rate tests is Nₜᵣ, and the i-th cutting feed rate Cv_{I-tr}[i] is set according to a following formula:
$${cv}_{I - tr} [ i ] = \frac{c {v}_{I - max}}{{N}_{t r}} i ,$$
and 1≤i≤Nₜᵣ, Cv_{I-max} represents a maximum cutting feed rate in the I-axis direction.

13. The method as claimed in claim 11, wherein the power set generated by the field test management module according to the power data information collected by the power sensors in the test process of CNC machine tool comprises: an input power set of the CNC machine tool in a power supply opening process D_{SP}; an input power set of the CNC machine tool in a CNC system operation process D_{SC}; the input power set D_{Au-i} of the CNC machine tool during an operation of an i-th auxiliary system, 1≤i≤N_{Au}; the input power set D_{PS-i} of the CNC machine tool, in a start-up process of an i-th spindle speed, 1≤i≤2 Nₜᵣ; an input power set D_{US-i} of the CNC machine tool in a process of an i-th spindle speed empty operation; an input power set D_{I-PF-i} of the CNC machine tool in a process of an i-th rapid feed&return distance in the feed shaft I, 1≤i≤Nₜᵣ; an input power set D_{I-UF-i} of the CNC machine tool in a feed axis I cutting a feed process at an i-th cutting speed, 1≤i≤Nₜᵣ; an input power set D_{PT-n}_{ₜ} of the CNC machine tool in a process of changing an nₜ-th tool position by the automatic tool changing system.

14. The method as claimed in claim 9, wherein the data analysis module is configured to establish an inherent energy efficiency factor discrete function of each energy consumption subsystem of the CNC machine tool by a discrete modeling method, comprising following steps:
step 2.1: calculating a power mean P̅_̅{̅D̅}̅, a set time t_{D} and a set energy consumption E_{D} for each power set, according to following general formula:
$$\overline{{P}_{D}} = \frac{1}{{N}_{D}} {\sum }_{k = 1}^{{N}_{D}} {P}_{k} , {P}_{k} ∈ D ; {t}_{D} = \frac{{N}_{D}}{f s} ; {E}_{D} = \frac{1}{f s} {\sum }_{k = 1}^{{N}_{D}} {P}_{k} , {P}_{k} ∈ D ,$$
wherein D represents the power set, Pₖ represents a k-th element in the power set D, N_{D} represents the number of elements in the power set D, and fs represents a sampling frequency of the power sensors;
step 2.2: setting up the inherent energy efficiency factor discrete function of each energy consumption subsystem of the CNC machine tool:
wherein a power consumption PSP of the CNC machine tool in a power supply opening process:
P_{SP}=P̅_̅{̅i̅n̅-̅S̅P̅}̅,
and P̅_̅{̅i̅n̅-̅S̅P̅}̅ represents a power average of the power set D_{SP} of the CNC machine tool in the power supply opening process,
a power consumption of a control system of the CNC machine tool P_{Cs}:
P_{Cs}=P̅_̅{̅i̅n̅-̅S̅C̅}̅−P_{SP},
and P̅_̅{̅i̅n̅-̅S̅C̅}̅ represents a power mean of the power set D_{SC} of the CNC machine tool in the operation process of the CNC system,
a power consumption of the auxiliary system P_{Au-i}:
P_{Au-i}=P̅_̅{̅i̅n̅-̅A̅u̅-̅i̅}̅−P̅_̅{̅i̅n̅-̅S̅C̅}̅,
and P̅_̅{̅i̅n̅-̅A̅u̅-̅i̅}̅ represents a power average of the power set D_{Au-I} of the CNC machine tool during the operation of the i-th auxiliary system, 1≤i≤N_{Au},
a discrete function of startup time and energy consumption of the spindle system is C_{S-PS}:
$${C}_{S - PS} = [ \begin{matrix}n & {t}_{S - PS} & {E}_{S - PS}\end{matrix} ] = [ \begin{matrix}n {s}_{S - tr} [ 1 ] & {t}_{S - PS} [ 1 ] & {E}_{S - PS} [ 1 ] \\ ⋮ & ⋮ & ⋮ \\ n {s}_{S - tr} [ i ] & {t}_{S - PS} [ i ] & {E}_{S - PS} [ i ] \\ ⋮ & ⋮ & ⋮ \\ n {s}_{S - tr} [ 2 {N}_{tr} ] & {t}_{S - PS} [ 2 {N}_{tr} ] & {E}_{S - PS} [ 2 {N}_{tr} ]\end{matrix} ] ,$$
and n represents a spindle speed and is an independent variable; both t_{S-PS} and E_{S-PS} are dependent variables, which are a starting time of the spindle system and a energy consumption of the spindle system. the t_{S-PS}[i] is a running time of the power set D_{PS-i} in the starting process of the CNC machine tool in the start-up process of the i-th spindle speed, 1≤i≤2 Nₜᵣ,
a calculation formula of E_{S-PS}[i] is as follows:
E_{S-PS}[i]=E_{in-PS}[i]−P̅_̅{̅i̅n̅-̅S̅C̅}̅t_{S-PS}[i],
and E_{S-PS}[i] is the set energy consumption of the power set D_{PS-i} of the CNC machine tool in a start-up process of an i-th spindle speed, 1≤i≤2 Nₜᵣ,
an idling power discrete function of the spindle system in a process of air operation C_{S-US}:
$${C}_{S - US} = [ \begin{matrix}n & {P}_{S - US}\end{matrix} ] = [ \begin{matrix}n {s}_{S - tr} [ 1 ] & {P}_{S - US} [ 1 ] \\ ⋮ & ⋮ \\ n {s}_{S - tr} [ i ] & {P}_{S - US} [ i ] \\ ⋮ & ⋮ \\ n {s}_{S - tr} [ 2 {N}_{tr} ] & {P}_{S - US} [ 2 {N}_{tr} ]\end{matrix} ] ,$$
and n represents the spindle speed and is the independent variable, P_{S-US} represents a power function of a spindle system in an air operation process as a dependent variable,
a calculation power formula of P_{S-US}[i] is as follows:
P_{S-US}[i]=P̅_̅{̅i̅n̅-̅U̅S̅}̅[i]−P̅_̅{̅i̅n̅-̅S̅C̅}̅,
and P̅_̅{̅i̅n̅-̅U̅S̅}̅[i] is a mean power of the power set D_{US-i} of the CNC machine tool in the process of the i-th spindle speed empty operation, 1≤i≤2 Nₜᵣ,
a discrete function C_{I-PF} of a rapid feed&return time and an energy consumption of the rapid feed&return of the feed shaft system of the CNC machine tool is:
$${C}_{I - PF} = [ \begin{matrix}{d}_{I - tr} & {t}_{I - P F} & {E}_{I - P F}\end{matrix} ] = [ \begin{matrix}{d}_{I - tr} [ 1 ] & {t}_{I - P F} [ 1 ] & {E}_{I - P F} [ 1 ] \\ ⋮ & ⋮ & ⋮ \\ {d}_{I - tr} [ i ] & {t}_{I - P F} [ i ] & {E}_{I - P F} [ i ] \\ ⋮ & ⋮ & ⋮ \\ {d}_{I - tr} [ {N}_{tr} ] & {t}_{I - P F} [ {N}_{tr} ] & {E}_{I - P F} [ {N}_{tr} ]\end{matrix} ]$$
and the subscripts I∈[X, Y, Z], X, Y, Z represent the X axis, the Y axis and the Z axis of the machine tool respectively, d_{I-tr} represents a rapid feed&return distance and is an independent variable, t_{I-PF} and E_{I-PF} are dependent variables, t_{I-PF} means a rapid feed&return time, E_{I-PF} means a rapid feed&return energy consumption, t_{I-PF} is a running time of a feed axis I in the power set D_{I-PF-i} of the CNC machine tool in a process of an i-th rapid feed&return distance in the feed shaft I, 1≤i≤Nₜᵣ,
a calculation formula of E_{I-FF}[i] is as follows:
E_{I-FF}[i]=E_{in-I-PF}[i]−P̅_̅{̅i̅n̅-̅S̅C̅}̅t_{I-PF}[i],
and E_{in-I-PF}[i] is a set energy consumption of the power set D_{I-PF-i} of the CNC machine tool in a process of an i-th rapid feed&return distance in the feed shaft I, 1≤i≤Nₜᵣ,
a discrete function C_{I-UF} of feed power in a cutting feed operation process of the feed shaft system is:
$${C}_{I - UF} = [ \begin{matrix}{cv}_{I - tr} & {P}_{I - UF}\end{matrix} ] = [ \begin{matrix}{cv}_{I - tr} [ 1 ] & {P}_{I - UF} [ 1 ] \\ ⋮ & ⋮ \\ {cv}_{I - tr} [ i ] & {P}_{I - UF} [ i ] \\ ⋮ & ⋮ \\ {cv}_{I - tr} [ {N}_{tr} ] & {P}_{I - UF} [ {N}_{tr} ]\end{matrix} ] ,$$
and cv_{I-tr} represents a cutting feed rate of I axis, which is an independent variable, P_{I-UF} represents a feed power of I-axis cutting and is a dependent variable,
a calculation formula of P_{I-UF}[i] is as follows:
P_{I-UF}[i]=P̅_̅{̅i̅n̅-̅I̅-̅U̅F̅}̅[i]−P̅_̅{̅i̅n̅-̅S̅C̅}̅,
and P̅_̅{̅i̅n̅-̅I̅-̅U̅F̅}̅[i] is a mean power of the power set D_{I-UF-i} of the CNC machine tool in the feed axis I cutting the feed process at the i-th cutting speed, 1≤i≤Nₜᵣ,
a discrete function C_{PT} of a tool changing time and energy consumption of the automatic tool changing system during a tool changing operation is:
$${C}_{PT} = [ \begin{matrix}{n}_{t} & {t}_{PT} & {E}_{PT}\end{matrix} ] = [ \begin{matrix}1 & {t}_{PT} [ 1 ] & {E}_{PT} [ 1 ] \\ ⋮ & ⋮ & ⋮ \\ {n}_{t} & {t}_{PT} [ {n}_{t} ] & {E}_{PT} [ {n}_{t} ] \\ ⋮ & ⋮ & ⋮ \\ {N}_{t} & {t}_{PT} [ {N}_{t} ] & {E}_{PT} [ {N}_{t} ]\end{matrix} ] ,$$
and nₜ represents a tool change position and is an independent variable, t_{PT} and E_{PT} are dependent variables, t_{PT} means a tool change time, E_{PT} means a tool change energy consumption of the tool changing system, t_{PT}[nₜ] is a running time for the power set D_{PT-nt} of the CNC machine tool in a process of changing an nₜ-th tool position by the automatic tool changing system,
a calculation formula of E_{PT}[nₜ] is as follows:
E_{PT}[nₜ]=E_{in-PT}[nₜ]−P̅_̅{̅i̅n̅-̅S̅C̅}̅t_{PT}[nₜ],
and E_{in-PT} [n,] is a set energy consumption of the power set D_{PT-n}_{ₜ} of the CNC machine tool in a process of changing an nₜ-th tool position by the automatic tool changing system, 1≤nₜ≤Nₜ.

15. The method as claimed in claim 14, wherein the data analysis module establishes an inherent energy efficiency factor fitting function of each energy consumption subsystem of CNC machine tool by adaptive fitting modeling method based on discrete modeling, comprising following steps:
step 2.3: regarding the inherent energy efficiency factor discrete function of each energy consumption subsystem of the CNC machine tool established by the discrete modeling method as a data set for fitting, and dividing the data set into a training set and a test set by a cross-validation method in machine learning;
step 2.4: fitting a first fitting function and a second fitting function by a least square method according to the training set;
step 2.5: by the test set, calculating errors of the first fitting function and the second fitting function according to an error function;
step 2.6: If the error of the first fitting function is less than the error of the second fitting function, selecting the first fitting function as the inherent energy efficiency factor function, otherwise, selecting the second fitting function as the inherent energy efficiency factor function;
therefore, establishing following fitting functions of each energy consumption subsystem:
the spindle system of CNC machine tool: a fitting function of a starting time length t_{S-PS}(n), a fitting function of a starting energy consumption E_{S-PS}(n) and a fitting function of an air operation power P_{S-US}(n) which are with the spindle speed n as the independent variable respectively;
the feed shaft system of CNC machine tool: a rapid feed&return time fitting function t_{I-PF}(d_{I}) which is with a rapid feed&return distance d_{I} as an independent variable, a rapid feed&return energy consumption fitting function E_{I-PF}(d_{I}) which is with the rapid feed&return distance d_{I} as the independent variable, a cutting feed power fitting function P_{I-UF}(cv_{I}) with a cutting feed rate cv_{I} as a independent variable;
the automatic tool changing system: a tool change time fitting function t_{PT}(nₜ) and a tool change energy consumption fitting function E_{PT}(nₜ) which are with the tool change position nₜ as an independent variable.

16. The method as claimed in claim 15, wherein the inherent energy efficiency factor functions of the CNC machine tool comprise a power function P_{in-S}(s_{Cs}) of the CNC machine tool in a standby stage, a power function P_{in-PA}(s_{Au-i}) of the CNC machine tool in an opening stage of the auxiliary system, an energy consumption function E_{in-PS}(n,s_{Au-i}) of the CNC machine tool in a starting stage of the spindle system, an energy consumption function E_{in-PF}(d_{I},s_{Au-i}) of the CNC machine tool in a rapid feed&return stage, an energy consumption function E_{in-PT}(nₜ,s_{Au-i}) of the CNC machine tool in an automatic tool change stage and a power function P_{in-U}(n,cv_{I},s_{Au-i}) of the CNC machine tool in an idling stage, specific expressions are as follows:
the power function P_{in-S}(s_{Cs}) of the CNC machine tool in the standby stage:
P_{in-S}(s_{Cs})=P_{SP}+s_{Cs}P_{Cs},
and P_{SP} represents a power consumption when a CNC machine tool power is turned on, and P_{Cs} represents a new power consumption when the CNC machine tool power is turned on, s_{Cs} means a state of the CNC system, s_{Cs}=0 means the state of the CNC system is closed, s_{Cs}=1 means the state of the CNC system is open;
the power function of the CNC machine tool in an opening stage of the auxiliary system P_{in-PA}(s_{Au-i}):
P_{in-PA}(s_{Au-i})=P_{S}+Σs_{Au-i}P_{Ai-i},
P_{S} represents a standby power of CNC machine tool, P_{S}=P_{in-S}(s_{Cs}=1); P_{Au-i} means a new machine tool power consumption when a first auxiliary system is opened, 1≤i·N_{Au}; s_{Au-i} represents a state of the i-th auxiliary system, 1≤i≤N_{Au}, S_{Au-i}=0 represents a closed state of the i-th auxiliary system, and s_{Au-i}=1 represents an open state of the i-th auxiliary system;
the energy consumption function E_{in-PS}(n,s_{Au-i}) of CNC machine tool in the starting stage of the spindle system:
E_{in-PS}(nₜ,S_{Au-i})=(P_{S}+Σs_{Au-i}P_{Au-i})t_{S-PS}(n)+E_{S-PS}(n),
and n denotes the spindle speed, t_{S-PS}(n) and E_{S-PS}(n) are a starting time function and an energy consumption function of the spindle system, respectively;
the energy consumption function E_{in-PF}(d_{I},s_{Au-i}) of CNC machine tool in the rapid feed&return stage:
E_{in-PF}(d_{I},s_{Au-i})=(P_{S}+Σs_{Au-i}P_{Au-i})Σt_{I-PF}(d_{I})+Σ_{I-PF}(d_{I}),
and t_{PT}(nₜ) and E_{PT}(nₜ) represent the rapid feed&return time fitting function, the rapid feed&return energy consumption fitting function of I axis respectively;
the energy consumption function E_{in-PT}(nₜ,s_{Au-i}) of CNC machine tool in the automatic tool change stage:
E_{in-PT}(nₜ,s_{Au-i})=(P_{S}+Σs_{Au-i}P_{Au-i})t_{PT}(nₜ)+E_{PT}(nₜ),
and nₜ represents the number of cutter positions that need to be rotated during automatic tool change; t_{PT}(nₜ) and E_{PT}(nₜ) represents the tool change time fitting function and the tool change energy consumption fitting function of the automatic tool changing system respectively;
the power function P_{in-U}(n,cv_{I},s_{Au-i}) in the idling stage of the CNC machine tool:
P_{in-U}(n,cv_{I},s_{Au-i})=P_{S}+P_{S-US}(n)+Σs_{Au-i}P_{Au-i}+ΣP_{I-UF}(cv_{I}),
Where P_{S-US}(n) represents the a fitting function of an air operation power of the spindle system; cv_{I} represents the feed rate and P_{I-UF}(cv_{I}) represents the a cutting feed power fitting function of the I axis.
